(19) United States
(12) Patent Application Publication
(10) Pub. No.: US 2025/0343340 A1
(43) Pub. Date: Nov. 6, 2025

(54) BALANCED LINE-UNBALANCED LINE CONVERTER AND ANTENNA DEVICE

(71) Applicant: Mitsubishi Electric Corporation, Tokyo (JP)

(72) Inventors: Takuma NISHIMURA, Tokyo (JP); Takeshi OSHIMA, Tokyo (JP); Hidenori YUKAWA, Tokyo (JP); Toru FUKASAWA, Tokyo (JP)

(73) Assignee: Mitsubishi Electric Corporation, Tokyo (JP)

(21) Appl. No.: 19/265,821

(22) Filed: Jul. 10, 2025

Related U.S. Application Data
(63) Continuation of application No. PCT/JP2023/000896, filed on Jan. 16, 2023.

(51) Int. Cl. H01P 1/00; H01P 3/08; H01Q 21/00

(52) U.S. Cl. CPC H01P 1/00; H01P 3/08; H01Q 21/0075

(57) ABSTRACT

A balanced line-unbalanced line converter includes a balanced-side line including a first transmission line having a first end portion as a first signal terminal and a second end portion short-circuited and a second transmission line having a first end portion as a second signal terminal and a second end portion short-circuited, an unbalanced-side line including a first transmission line portion having a first end portion as a third signal terminal and a second end portion as an open end, the first transmission line portion to constitute a first coupled line with the first transmission line and a second transmission line portion to constitute a second coupled line with the second transmission line, a first open stub connected to the first end portion of the second transmission line, and a second open stub connected to the unbalanced-side line, to constitute a third coupled line with the first open stub.

### CROSS REFERENCE TO RELATED APPLICATION

This application is a Continuation of PCT International Application No. PCT/JP2023/000896, filed on Jan. 16, 2023, which is hereby expressly incorporated by reference into the present application.

### TECHNICAL FIELD

The present disclosure relates to a balanced line-unbalanced line converter that converts a balanced signal, a so-called differential signal, into an unbalanced signal, a so-called single-phase signal, or converts an unbalanced signal into a balanced signal.

### BACKGROUND ART

A Marchand balun, which is a type of a balanced line-unbalanced line converter, is disclosed in Non-Patent Literature 1.

The Marchand balun disclosed in Non-Patent Literature 1 includes one set of coupled transmission-line sections (one set of coupled transmission-line sections, hereinafter abbreviated as two coupled transmission lines) and two identical uncoupled transmission-line sections (two identical uncoupled transmission-line sections, hereinafter referred to as two uncoupled transmission lines).

In the Marchand balun configured as described above, since there is a gap in manufacturing between the two coupled transmission lines, a connecting segment is interposed between the two uncoupled transmission lines.

As a result, parasitic inductance due to the connecting segment, and the electrical characteristics of the Marchand balun are deteriorated.

In Non-Patent Literature 1, in order to compensate for the parasitic inductance due to the connecting segment, a vertically installed planar structure (VIP) with a height wv is formed at the termination of the two coupled transmission lines.

### CITATION LIST

### Non-Patent Literatures

Non-Patent Literature 1: Hee-Ran Ahn, “Novel Generic Asymmetric and Symmetric Equivalent Circuits of 90° coupled Transmission-Line Sections Applicable to Marchand Baluns,” IEEE TRANSACTIONS ON MICROWAVE THEORY AND TECHNIQUES, VOL. 65, NO. 3, March 2017, p.p. 746-760

### SUMMARY OF INVENTION

### Technical Problem

Since the Marchand balun disclosed in Non-Patent Literature 1 is configured as described above, the Marchand balun has a three-dimensional structure called VIP. The structure is complicated, and it is difficult to use the Marchand balun for a planar array antenna or the like in which a plurality of antenna elements are arranged on the same substrate, and the structure is not suitable for downsizing.

The present disclosure has been made in view of the above points, and an object of the present disclosure is to obtain a balanced line-unbalanced line converter that can be downsized while improving a pass phase difference between two transmission lines that transmit a balanced signal.

### Solution to Problem

A balanced line-unbalanced line converter according to the present disclosure includes a balanced-side line including a first transmission line having a first end portion as a first signal terminal and a second end portion short-circuited, and a second transmission line having a first end portion as a second signal terminal and a second end portion short-circuited, an unbalanced-side line including a first transmission line portion having a first end portion as a third signal terminal and a second end portion as an open end, the first transmission line portion to constitute a first coupled line with the first transmission line, and a second transmission line portion to constitute a second coupled line with the second transmission line, a first open stub connected to the first end portion of the second transmission line, and a second open stub connected to the unbalanced-side line, the second open stub to constitute a third coupled line with the first open stub.

### Advantageous Effects of Invention

According to the present disclosure, since the first open stub connected to one end portion of the second transmission line and the second open stub connected to the unbalanced-side line and constituting the third coupled line with the first open stub are provided, the electrical characteristics of the balanced line-unbalanced line converter can be improved with a simple and compact configuration.

### BRIEF DESCRIPTION OF DRAWINGS

FIG. 1 is a configuration perspective view illustrating a main part of a balanced line-unbalanced line converter according to a first embodiment.

FIG. 2 is a perspective view illustrating a balanced-side line and an unbalanced-side line in the balanced line-unbalanced line converter according to the first embodiment, as viewed from a back surface of a dielectric substrate (ground layers on a front surface layer and a back surface layer are omitted).

FIG. 3 is a top view illustrating the balanced-side line in the balanced line-unbalanced line converter according to the first embodiment.

FIG. 4 is a top view illustrating the unbalanced-side line in the balanced line-unbalanced line converter according to the first embodiment.

FIG. 5 is a cross-sectional view taken along line A-A in FIG. 2.

FIG. 6 is a cross-sectional view taken along line B-B in FIG. 2.

FIG. 7 is a diagram illustrating an equivalent circuit in the balanced line-unbalanced line converter according to the first embodiment.

FIG. 8 is a diagram illustrating an equivalent circuit in a balanced line-unbalanced line converter as a comparative example.

FIG. 9 is a diagram illustrating reflection characteristics in the balanced line-unbalanced line converter according to the first embodiment.

FIG. 10 is a diagram illustrating pass characteristics in the balanced line-unbalanced line converter according to the first embodiment.

FIG. 11 is a diagram illustrating a pass phase difference in the balanced line-unbalanced line converter according to the first embodiment.

FIG. 12 is a top view illustrating a part of a second transmission line of a balanced-side line and a first stub in a balanced line-unbalanced line converter according to a second embodiment.

FIG. 13 is a top view illustrating a part of a second transmission line of a balanced-side line and a first stub in a balanced line-unbalanced line converter according to a third embodiment.

FIG. 14 is a top view illustrating a balanced-side line and a first stub in a balanced line-unbalanced line converter according to a fourth embodiment.

FIG. 15 is a top perspective view illustrating a balanced-side line and an unbalanced-side line in a balanced line-unbalanced line converter according to a fifth embodiment.

FIG. 16 is a top perspective view illustrating a balanced-side line and an unbalanced-side line in a balanced line-unbalanced line converter according to a sixth embodiment.

FIG. 17 is a top view illustrating the balanced-side line in the balanced line-unbalanced line converter according to the sixth embodiment.

FIG. 18 is a top view illustrating the unbalanced-side line in the balanced line-unbalanced line converter according to the sixth embodiment.

FIG. 19 is a top view illustrating a balanced-side line in a balanced line-unbalanced line converter according to a seventh embodiment.

FIG. 20 is a top perspective view illustrating a balanced-side line and an unbalanced-side line in a balanced line-unbalanced line converter according to an eighth embodiment.

FIG. 21 is a schematic configuration diagram illustrating an antenna device according to a ninth embodiment.

FIG. 22 is a schematic configuration diagram illustrating an antenna device according to a tenth embodiment.

FIG. 23 is a schematic configuration diagram illustrating an array antenna device according to an eleventh embodiment.

FIG. 24 is a schematic configuration diagram illustrating an array antenna device according to a twelfth embodiment.

FIG. 25 is a schematic configuration diagram illustrating an array antenna device according to a thirteenth embodiment.

### DESCRIPTION OF EMBODIMENTS

### First Embodiment

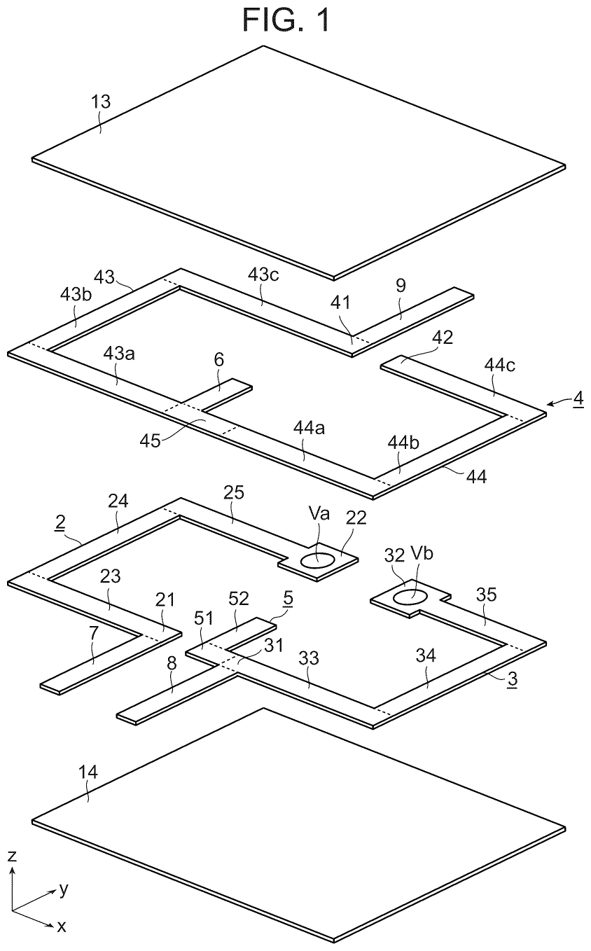

A balanced line-unbalanced line converter according to a first embodiment will be described with reference to FIGS. 1 to 11.

The balanced line-unbalanced line converter according to the first embodiment can be used for any of a balanced line-unbalanced line converter that converts a balanced signal, a so-called differential signal, into an unbalanced signal, a so-called single-phase signal, and a balanced line-unbalanced line converter that converts an unbalanced signal into a balanced signal.

The balanced line-unbalanced line converter according to the first embodiment is suitable for a balanced line-unbalanced line converter that operates mainly at a high frequency such as in the sub-terahertz band or the terahertz band.

In the following description, since the description is complicated, the balanced line-unbalanced line converter that converts a balanced signal into an unbalanced signal will be mainly described.

As illustrated in FIGS. 1 to 6, the balanced line-unbalanced line converter according to the first embodiment includes a multilayer dielectric substrate 1, a balanced-side line including a first transmission line 2 and a second transmission line 3, an unbalanced-side line 4, a first open stub 5, a second open stub 6, a first signal line 7, a second signal line 8, and a third signal line 9.

The dielectric substrate 1 has at least a first conductor layer 11 and a second conductor layer 12 therein, has a ground layer 13 on one main surface, in this example, a front surface, and has a ground layer 14 on the other main surface, in this example, a back surface.

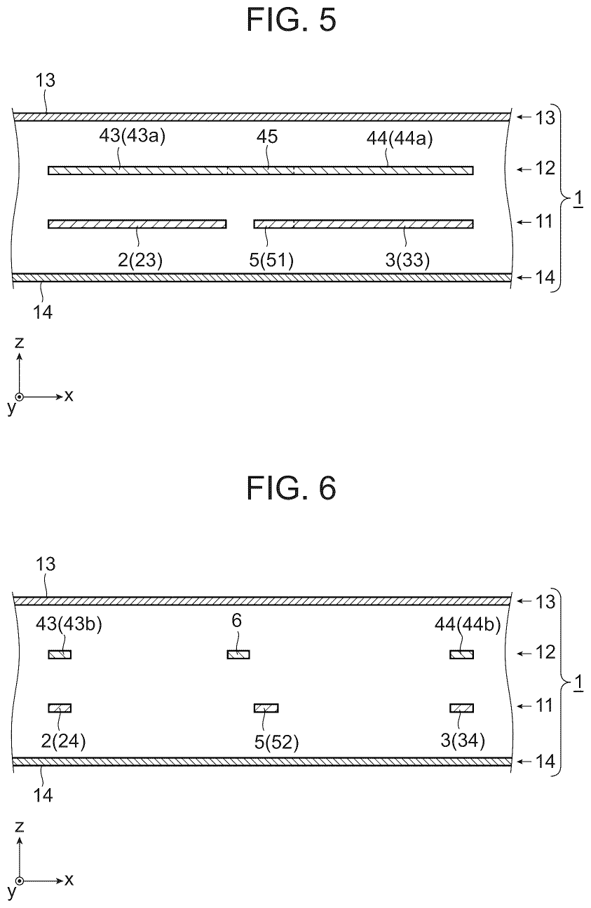

In the dielectric substrate 1, the first conductor layer 11 and the second conductor layer 12 are sequentially formed in a direction from the back surface to the front surface, that is, an interlayer direction, or a vertical direction (hereinafter, referred to as “Z-axis direction”) on the paper surface illustrated in FIGS. 5 and 6.

Note that the first conductor layer 11 and the second conductor layer 12 may be sequentially formed in a direction from the front surface to the back surface.

A material such as a resin substrate or a ceramic substrate is selected for the dielectric substrate 1.

These materials may be selected depending on the desired cost and electrical characteristics.

Note that in a case where the balanced line-unbalanced line converter according to the first embodiment is incorporated in a multilayer dielectric substrate used in an antenna device, for example, a high-frequency package completed at a preceding stage of an antenna element in the antenna device, that is, a radio frequency integrated circuit (RFIC: Radio Frequency Integrated Circuit), or a multilayer dielectric substrate used in a high-frequency module not including an antenna element, a first conductor layer, a second conductor layer, a conductor layer on a front surface, and a conductor layer on a back surface in the dielectric substrate other than a region in which the balanced line-unbalanced line converter is incorporated are also used as wiring layers.

In this example, the dielectric substrate 1 having four layers is illustrated, but the dielectric substrate 1 only needs to have at least the first conductor layer 11 and the second conductor layer 12 therein, and may have four or more layers.

The dielectric substrate 1 having four layers or four or more layers is appropriately selected depending on the application in which the balanced line-unbalanced line converter is incorporated.

For example, in a case where the balanced line-unbalanced line converter is incorporated in the dielectric substrate 1 together with a passive circuit or an active circuit, the balanced line-unbalanced line converter may be incorporated in the dielectric substrate 1 having four or more layers in consideration of wiring of transmission lines with the passive circuit or the active circuit.

In the first transmission line 2 constituting the balanced-side line, one end portion 21 is a first signal terminal, and the other end portion 22 is short-circuited.

The first transmission line 2 is formed in the first conductor layer 11 of the dielectric substrate 1.

The one end portion 21 of the first transmission line 2 is connected to the first signal line 7 formed in the first conductor layer 11 of the dielectric substrate 1.

The first transmission line 2 and the first signal line 7 are integrally formed by a continuous conductor layer.

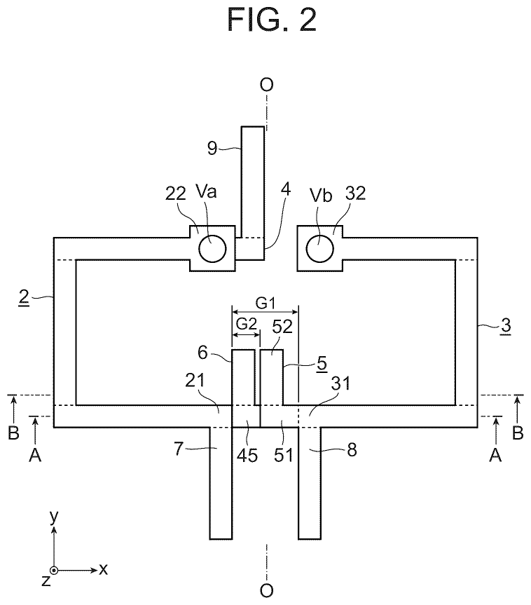

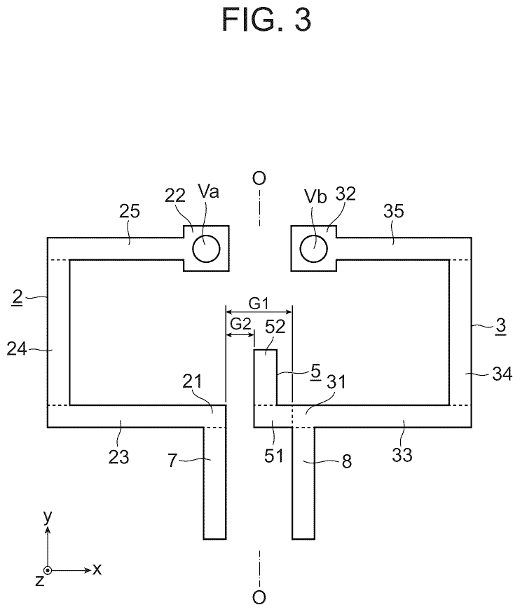

As illustrated in FIGS. 2 and 3, the first signal line 7 is formed linearly in the vertical direction on the paper surface (hereinafter, referred to as “Y-axis direction”), that is, formed linearly in the − direction of the Y axis (downward direction on the paper surface) from the one end portion 21 of the first transmission line 2 in this example.

In a case where one balanced signal from a balanced line or a balanced circuit (hereinafter, the balanced line and the balanced circuit are collectively referred to as “balanced line”) is input, the first signal line 7 functions as a first input signal line, and the first signal terminal 21 of the first transmission line 2 functions as an input terminal.

In a case where the first signal line 7 outputs one balanced signal to the balanced line, the first signal line functions as a first output signal line, and the first signal terminal 21 of the first transmission line 2 functions as an output terminal.

In a case where the first signal line 7 inputs and outputs one balanced signal to and from the balanced line, the first signal line functions as a first input/output signal line, and the first signal terminal 21 of the first transmission line 2 functions as an input/output terminal.

The other end portion 22 of the first transmission line 2 is connected to the ground layer, in this example, the ground layer 14 on the back surface via a via (VIA) Va.

As illustrated in FIGS. 2 and 3, the first transmission line 2 includes a first line portion 23 extending from the first signal line 7 to be bent outward at a right angle, that is, bent at the one end portion 21 in a left direction on the paper surface (hereinafter, the horizontal direction on the paper surface is referred to as “X-axis direction”, and the left direction is referred to as “− direction”), a second line portion 24 extending from the first line portion 23 to be bent at a right angle in a + direction of the Y axis, and a third line portion 25 extending from the second line portion 24 to be bent inward at a right angle, that is, bent at a right angle in a + direction of the X axis.

That is, the first line portion 23, the second line portion 24, and the third line portion 25 in the first transmission line 2 are integrally formed by a continuous conductor layer, and constitute three sides of a rectangle.

The first line portion 23 and the third line portion 25 face each other and are arranged parallel to the X axis.

The length of the first transmission line 2, that is, the length from the one end portion 21 to the other end portion 22 is a length of 90 degrees with respect to the center frequency of a signal to be transmitted.

In the second transmission line 3 constituting the balanced-side line, one end portion 31 is a second signal terminal, and the other end portion 32 is short-circuited.

The second transmission line 3 is formed in the first conductor layer 11 of the dielectric substrate 1.

The one end portion 31 of the second transmission line 3 is connected to the second signal line 8 formed in the first conductor layer 11 of the dielectric substrate 1.

The second transmission line 3 and the second signal line 8 are integrally formed by a continuous conductor layer.

As illustrated in FIGS. 2 and 3, in this example, the second signal line 8 is formed linearly in the − direction of the Y axis from the one end portion 31 of the second transmission line 3, and is disposed parallel with the first signal line 7.

In a case where the other balanced signal from the balanced line is input, the second signal line 8 functions as a second input signal line, and the second signal terminal 31 of the second transmission line 3 functions as an input terminal.

In a case where the second signal line 8 outputs the other balanced signal to the balanced line, the second signal line functions as a second output signal line, and the second signal terminal 31 of the second transmission line 3 functions as an output terminal.

In a case where the second signal line 8 inputs and outputs the other balanced signal to and from the balanced line, the second signal line functions as a second input/output signal line, and the second signal terminal 31 of the second transmission line 3 functions as an input/output terminal.

The other end portion 32 of the second transmission line 3 is connected to the ground layer, in this example, the ground layer 14 on the back surface via a via (VIA) Vb.

As illustrated in FIGS. 2 and 3, the second transmission line 3 includes a first line portion 33 extending at the one end portion 31 to be bent outward at a right angle, that is, bent in a + direction of the X axis, a second line portion 34 extending from the first line portion 33 to be bent at a right angle in the + direction of the Y axis, and a third line portion 35 extending from the second line portion 34 to be bent inward at a right angle, that is, bent at a right angle in the − direction of the X axis.

That is, the first line portion 33, the second line portion 34, and the third line portion 35 in the second transmission line 3 are integrally formed by a continuous conductor layer, and constitute three sides of a rectangle.

The first line portion 33 and the third line portion 35 face each other and are arranged parallel to the X axis.

The length of the second transmission line 3, that is, the length from the one end portion 31 to the other end portion 32 is a length of 90 degrees with respect to the center frequency of a signal to be transmitted.

An end surface of the one end portion 21 of the first transmission line 2 and an end surface of the one end portion 31 of the second transmission line 3 are arranged to face each other.

The end surface of the one end portion 21 of the first transmission line 2 and the end surface of the one end portion 31 of the second transmission line 3 are arranged with a gap G1 therebetween in order to obtain the impedance of the first transmission line 2 and the second transmission line 3.

The first signal line 7 and the second signal line 8 are also arranged at the same interval as the gap G1.

An end surface of the other end portion 22 of the first transmission line 2 and an end surface of the other end portion 32 of the second transmission line 3 are arranged to face each other with an interval therebetween.

The second line portion 24 of the first transmission line 2 and the second line portion 34 of the second transmission line 3 face each other and are arranged parallel with the Y axis.

In short, the first transmission line 2 and the second transmission line 3 are arranged line-symmetrically with respect to a center line O-O illustrated in FIGS. 2 and 3 and have the same shape.

The center line O-O is a virtual line positioned at the center of the first signal line 7 and the second signal line 8 and extending in the Y-axis direction in parallel with the first signal line 7 and the second signal line 8.

In the unbalanced-side line 4, one end portion 41 is a third signal terminal, and the other end portion 42 is an open end.

The unbalanced-side line 4 includes a first transmission line portion 43 that constitutes a first coupled line C1 with the first transmission line 2, a second transmission line portion 44 that constitutes a second coupled line C2 with the second transmission line 3, and a connecting line portion 45 that connects the first transmission line portion 43 and the second transmission line portion 44.

The unbalanced-side line 4 is formed in the second conductor layer 12 of the dielectric substrate 1.

The first transmission line portion 43 of the unbalanced-side line 4 is disposed to face the first transmission line 2 in the Z-axis direction.

The second transmission line portion 44 of the unbalanced-side line 4 is disposed to face the second transmission line 3 in the Z-axis direction.

The first transmission line portion 43 and the second transmission line portion 44 are continuously formed via the connecting line portion 45.

The one end portion 41 of the unbalanced-side line 4 is disposed at a position facing the other end portion 22 of the first transmission line 2 in the Z-axis direction.

The other end portion 42 of the unbalanced-side line 4 is disposed at a position facing the other end portion 32 of the second transmission line 3 in the Z-axis direction.

One end portion of the first transmission line portion 43 of the unbalanced-side line 4 is the one end portion 41 of the unbalanced-side line 4, and the other end portion of the second transmission line portion 44 of the unbalanced-side line 4 is the other end portion 42 of the unbalanced-side line 4.

An end surface of the one end portion 41 of the unbalanced-side line 4 is located closer to the other end portion 42 than the end surface of the other end portion 22 of the first transmission line 2.

An end surface of the other end portion 42 of the unbalanced-side line 4 is located on a plane formed in the Z-axis direction with an end surface of the other end portion 32 of the second transmission line 3.

The interval between the end surface of the one end portion 41 of the unbalanced-side line 4 and the end surface of the other end portion 42 is narrower than the gap G1 between the end surface of the one end portion 21 of the first transmission line 2 and the end surface of the one end portion 31 of the second transmission line 3.

The connecting line portion 45 of the unbalanced-side line 4 is disposed to face the gap G1 between the first transmission line 2 and the second transmission line 3 in the Z-axis direction.

The first transmission line portion 43, the second transmission line portion 44, and the connecting line portion 45 in the unbalanced-side line 4 are integrally formed by a continuous conductor layer, and constitute four sides of a rectangle except for the interval between the end surface of the one end portion 41 and the end surface of the other end portion 42.

The one end portion 41 of the unbalanced-side line 4 is connected to the third signal line 9 formed in the second conductor layer 12.

The unbalanced-side line 4 and the third signal line 9 are integrally formed by a continuous conductor layer.

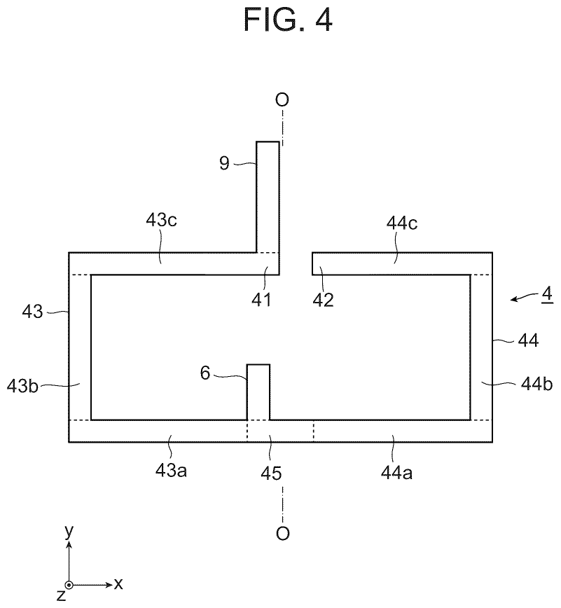

As illustrated in FIGS. 2 and 4, the third signal line 9 is formed linearly in the + direction of the Y axis from the one end portion 41 of the unbalanced-side line 4.

The third signal line 9 is located on the opposite side in the Y-axis direction with respect to the first signal line 7 and the second signal line 8.

In a case where an unbalanced signal from an unbalanced line is input, the third signal line 9 functions as an input signal line, and the third signal terminal 41 of the unbalanced-side line 4 functions as an input terminal.

In a case where the third signal line 9 outputs an unbalanced signal to the unbalanced line, the third signal line functions as an output signal line, and the third signal terminal 41 of the unbalanced-side line 4 functions as an output terminal.

In a case where the third signal line 9 inputs and outputs an unbalanced signal to and from the unbalanced line, the third signal line functions as a third input/output signal line, and the third signal terminal 41 of the unbalanced-side line 4 functions as an input/output terminal.

The first transmission line portion 43 of the unbalanced-side line 4 includes a first line portion 43a, a second line portion 43b, and a third line portion 43c that are arranged to face the first line portion 23, the second line portion 24, and the third line portion 25 of the first transmission line 2, respectively, in the Z-axis direction via an insulating layer.

The third line portion 43c extends from the third signal terminal 41 to be bent outward at a right angle, that is, bent at the one end portion 41 in the − direction of the X axis, the second line portion 43b extends from the third line portion 43c to be bent at a right angle in the − direction of the Y axis, the first line portion 43a extends from the second line portion 43b to be bent inward at a right angle, that is, bent at a right angle in the + direction of the X axis, and the other end of the first line portion 43a is one end of the connecting line portion 45.

The second transmission line portion 44 of the unbalanced-side line 4 includes a first line portion 44a, a second line portion 44b, and a third line portion 44c that are arranged to face the first line portion 33, the second line portion 34, and the third line portion 35 of the second transmission line 3, respectively, in the Z-axis direction via an insulating layer.

The third line portion 44c extends outward, that is, in the + direction of the X axis from the open end 42, the second line portion 44b extends from the third line portion 44c to be bent at a right angle in the − direction of the Y axis, the first line portion 44a extends from the second line portion 44b to be bent inward at a right angle, that is, bent at a right angle in the − direction of the X axis, and one end of the first line portion 44a is the other end of the connecting line portion 45.

The length of the unbalanced-side line 4, that is, the length from the one end portion 41 to the other end portion 42 via the first transmission line portion 43, the second transmission line portion 44, and the connecting line portion 45 is a length of 180 degrees with respect to the center frequency of a signal to be transmitted.

The first transmission line 2 and the second transmission line 3, and the first signal line 7 and the second signal line 8, constituting the balanced-side line are formed as strip lines sandwiched between the ground layer 13 formed on the front surface of the dielectric substrate 1 and the ground layer 14 formed on the back surface.

The first transmission line portion 43, the second transmission line portion 44, and the connecting line portion 45, and the third signal line 9 of the unbalanced-side line 4 are formed as strip lines sandwiched between the ground layer 13 and the ground layer 14.

By forming the balanced-side line and the unbalanced-side line 4 using the strip lines in this manner, the effective relative permittivity of the base material of the dielectric substrate 1 in the balanced-side line can match that in the unbalanced-side line 4.

Note that one of the balanced-side line and the unbalanced-side line 4 may be formed not by a strip line but by a microstrip line forming a line on the front surface or the back surface of the dielectric substrate 1.

As illustrated in FIG. 2, the first transmission line 2 constituting the balanced-side line and the first transmission line portion 43 of the unbalanced-side line 4, and the second transmission line 3 constituting the balanced-side line and the second transmission line portion 44 of the unbalanced-side line 4 completely overlap when viewed through the back surface of the dielectric substrate 1.

That is, the first transmission line 2, the second transmission line 3, and the unbalanced-side line 4 have the same width, the first transmission line 2 and the first transmission line portion 43 have the same shape, the second transmission line 3 and the second transmission line portion 44 have the same shape, and their X-axis direction and their Y-axis direction match each other.

Note that, in order to adjust the coupling amount in the first coupled line C1 including the first transmission line 2 and the first transmission line portion 43 and the coupling amount in the second coupled line C2 including the second transmission line 3 and the second transmission line portion 44, the degree of overlap between the first transmission line 2 and the first transmission line portion 43 in the X-axis direction and the Y-axis direction and the degree of overlap between the second transmission line 3 and the second transmission line portion 44 in the X-axis direction and the Y-axis direction may be shifted.

In addition, the widths of the first transmission line 2, the second transmission line 3, and the unbalanced-side line 4 may be different depending on the characteristic impedance of each line.

The first open stub 5 is connected to the one end portion 31 of the second transmission line 3 constituting the balanced-side line.

The first open stub 5 is formed in the first conductor layer 11 of the dielectric substrate 1.

That is, the first open stub 5 is connected to one end portion of the second transmission line 3 constituting the second coupled line C2 with the second transmission line portion 44 located on the open end 42 side in the unbalanced-side line 4, that is, the end portion to which the second signal line 8 is connected.

The first open stub 5 is formed integrally with the second transmission line 3 by the first conductor layer 11 at the end portion of the second transmission line 3 where the gap G1 between the first transmission line 2 and the second transmission line 3 is located.

The first open stub 5 extends inward, that is, in the + direction of the Y axis from one end portion of the second transmission line 3.

As illustrated in FIGS. 2 and 3, the first open stub 5 includes an extending portion 51 that extends inward, that is, in the − direction of the X axis from the one end portion 31 of the second transmission line 3 and a coupled portion 52 that extends from the extending portion 51 to be bent at a right angle in the + direction of the Y axis and faces the second open stub 6.

A side end surface of the coupled portion 52 located on one end side of the first transmission line 2 is disposed on one end side of the first transmission line 2 with respect to the center line O-O illustrated in FIG. 3.

The length of the first open stub 5, strictly the length of the coupled portion 52, is a length of a fraction of the wavelength at the center frequency of a signal to be transmitted, for example, a length of 1/30 wavelength to ¼ wavelength.

For example, assuming that, in an RFIC, the balanced-side line including the first transmission line 2 and the second transmission line 3 and the unbalanced-side line 4 are respectively formed in the first conductor layer 11 and the second conductor layer 12 located in the inner layers of the multilayer dielectric substrate 1, and the thickness of the insulating layer between the first conductor layer 11 and the second conductor layer 12 is several microns, the length of the first open stub 5 is preferably about 1/20 wavelength.

The second open stub 6 is connected to the unbalanced-side line 4.

The second open stub 6 is formed in the second conductor layer 12 of the dielectric substrate 1.

The second open stub 6 constitutes the third coupled line C3 with the first open stub 5.

The second open stub 6 is connected to one end portion of the connecting line portion 45 of the unbalanced-side line 4 in such a way as to be in contact with the other end of the first line portion 43a of the first transmission line portion 43 in the unbalanced-side line 4.

The second open stub 6 extends inward, that is, in the + direction of the Y axis from the connecting line portion 45 of the unbalanced-side line 4.

The second open stub 6 is disposed to face the first open stub 5 via the insulating layer, and is located on the first transmission line 2 side with respect to the first open stub 5 in the X-axis direction.

A side end surface of the second open stub 6 located on one end side of the second transmission line 3 is disposed on one end side of the first transmission line 2 with respect to the center line O-O illustrated in FIG. 2.

The second open stub 6 and the coupled portion 52 of the first open stub 5 are arranged as two straight lines parallel to the Y axis, and the second open stub 6 and the coupled portion 52 of the first open stub 5 constitute the third coupled line C3.

The coupled portion 52 of the first open stub 5 and the second open stub 6 are arranged asymmetrically with respect to the center line O-O.

Since the coupled portion 52 of the first open stub 5 and the second open stub 6 constitute the third coupled line C3 via the insulating layer, the coupled portion 52 and the second open stub 6 constitute a capacitor.

The first open stub 5 and the second open stub 6 function as capacitive elements.

As a result, the capacitances of the coupled portion 52 and the second open stub 6 and the capacitances of the first open stub 5 and the second open stub 6 function to cancel the parasitic inductance due to the connecting line portion 45 of the unbalanced-side line 4.

Since the parasitic inductance due to the connecting line portion 45 can be canceled by the capacitances of the first open stub 5 and the second open stub 6 constituting the third coupled line C3, it is possible to suppress deterioration in the electrical characteristics of the balanced line-unbalanced line converter caused by the parasitic inductance due to the connecting line portion 45, that is, deterioration of the pass phase difference between the first transmission line 2 and the second transmission line 3 in the balanced-side line, and to improve the pass phase difference.

In addition, since the extending portion 51 of the first open stub 5 acts to fill the gap G1 between the first transmission line 2 and the second transmission line 3, the pass phase difference between the first transmission line 2 and the second transmission line 3 can be further improved.

That is, the gap G2 between the end surface of the extending portion 51 and the end surface of the one end portion 21 of the first transmission line 2 is narrower than the gap G1 as illustrated in FIGS. 2 and 3, and the length of the connecting line portion 45 of the unbalanced-side line 4 can be substantially reduced. Therefore, the parasitic inductance due to the connecting line portion 45 can be reduced, and the deterioration in the electrical characteristics caused by the connecting line portion 45 can be reduced.

As a result, the pass phase difference between the first transmission line 2 and the second transmission line 3 can be improved.

The length of the second open stub 6 is a length of a fraction of the wavelength at the center frequency of a signal to be transmitted, for example, a length of 1/30 wavelength to ¼ wavelength.

For example, assuming that, in the RFIC, the balanced-side line including the first transmission line 2 and the second transmission line 3 and the unbalanced-side line 4 are respectively formed in the first conductor layer 11 and the second conductor layer 12 located in the inner layers of the multilayer dielectric substrate 1, and the thickness of the insulating layer between the first conductor layer 11 and the second conductor layer 12 is several microns, the length of the second open stub 6 is preferably about 1/20 wavelength.

As described above, since the length of the first open stub 5 and the length of the second open stub 6 is a fraction of the wavelength, the balanced line-unbalanced line converter does not increase in size due to the first open stub 5 and the second open stub 6.

Moreover, since the first open stub 5 and the second open stub 6 are arranged inside the balanced-side line and the unbalanced-side line 4, even if the first open stub 5 and the second open stub 6 are provided, the size of the balanced line-unbalanced line converter is not affected, and the balanced line-unbalanced line converter can be downsized.

Note that the positional relationship between the first open stub 5 and the second open stub 6 only needs to obtain the set coupling amount in the third coupled line C3, and thus, as illustrated in FIG. 2, the positional relationship may be shifted in the X-axis direction, and the coupled portion 52 of the first open stub 5 and the second open stub 6 may overlap each other in the X-axis direction.

Next, an operation of the balanced line-unbalanced line converter according to the first embodiment will be described.

A balanced line-unbalanced line converter that converts a balanced signal into an unbalanced signal will be described.

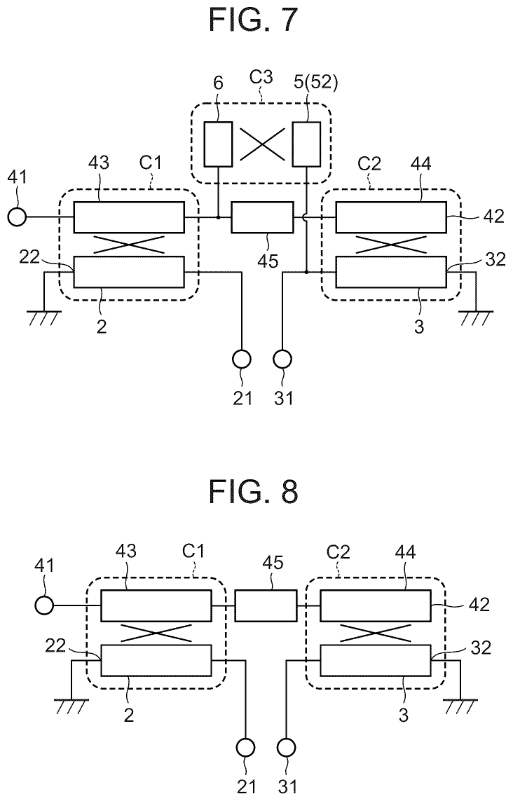

FIG. 7 illustrates an equivalent circuit diagram of the balanced line-unbalanced line converter according to the first embodiment.

One balanced signal flowing through the first signal line 7 is input to the first signal terminal 21 and flows to the first transmission line 2.

One signal flowing through the first transmission line 2 flows as an unbalanced signal to the first transmission line portion 43 by electromagnetic field coupling between the first transmission line 2 and the first transmission line portion 43 of the unbalanced-side line 4 constituting the first coupled line C1, and is output from the third signal terminal 41 to the third signal line 9.

The other balanced signal flowing through the second signal line 8 is input to the second signal terminal 31 and flows to the second transmission line 3.

The other signal flowing through the second transmission line 3 flows as an unbalanced signal to the second transmission line portion 44 by electromagnetic field coupling between the second transmission line 3 and the second transmission line portion 44 of the unbalanced-side line 4 constituting the second coupled line C2, and is output from the third signal terminal 41 to the third signal line 9 via the connecting line portion 45 and the first transmission line 2.

As illustrated in FIG. 7, the third coupled line C3 including the first open stub 5 and the second open stub 6 is connected parallel with the connecting line portion 45.

Since the LC circuit including the inductance of the connecting line portion 45 and the capacitance of the third coupled line C3 performs impedance matching between the other end of the first transmission line portion 43 and one end of the second transmission line portion 44 in the unbalanced-side line 4, the pass phase difference between the first transmission line 2 and the second transmission line 3 with respect to the unbalanced-side line 4 is improved.

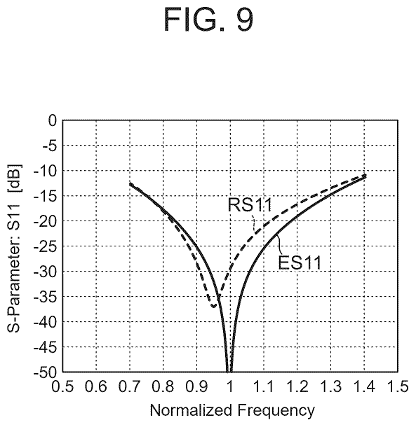

The point that the pass phase difference is improved by providing the third coupled line C3 including the first open stub 5 and the second open stub 6 in the balanced line-unbalanced line converter according to the first embodiment will be described with reference to FIGS. 9 to 11.

FIG. 9 is a diagram illustrating reflection characteristics at the third signal terminal 41 (output terminal: reflection end) of the unbalanced-side line 4, which is one of electromagnetic field analysis results of the balanced line-unbalanced line converter.

In FIG. 9, the horizontal axis represents the frequency normalized by the center frequency of a signal to be transmitted, the vertical axis represents the reflection amplitude S-Parameter: S11 [dB], the solid line ES11 represents the reflection characteristic curve in the first embodiment, and the broken line RS11 represents the reflection characteristic curve in the comparative example.

The comparative example uses a balanced line-unbalanced line converter that has the same configuration as the balanced line-unbalanced line converter according to the first embodiment except that the first open stub 5 and the second open stub 6 of the balanced line-unbalanced line converter according to the first embodiment are not provided.

FIG. 8 illustrates an equivalent circuit of the comparative example.

As can be understood from FIG. 9, for the reflection characteristics in the first embodiment, the third coupled line C3 including the first open stub 5 and the second open stub 6 is provided, and thus, although the resonance frequency is slightly deviated from that in the comparative example, the level of the reflection amplitude is equivalent, and the third coupled line C3 does not significantly affect the reflection characteristics.

That is, the reflection characteristics of the first embodiment are comparable to those of the comparative example.

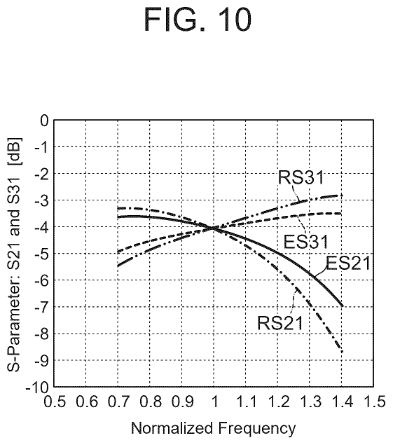

FIG. 10 is a diagram illustrating pass characteristics from the input terminal of the balanced-side line to the third signal terminal 41 (output terminal) of the unbalanced-side line 4, which is one of the electromagnetic field analysis results of the balanced line-unbalanced line converter.

In FIG. 10, the horizontal axis represents the frequency normalized by the center frequency of a signal to be transmitted, the vertical axis represents the pass amplitude S-Parameter: S21 and S31 [dB], the solid line ES21 represents the pass characteristic curve from the first signal terminal 21 (first input terminal) of the first transmission line 2 to the third signal terminal 41 (output terminal) of the unbalanced-side line 4 in the first embodiment, the broken line ES31 represents the pass characteristic curve from the second signal terminal 31 (second input terminal) of the second transmission line 3 to the third signal terminal 41 (output terminal) of the unbalanced-side line 4 in the first embodiment, the one-dot chain line RS21 represents the pass characteristic curve from the first input terminal of the first transmission line to the output terminal of the unbalanced-side line in the comparative example, and the two-dot chain line RS31 represents the pass characteristic curve from the second input terminal of the second transmission line to the output terminal of the unbalanced-side line in the comparative example.

As can be understood from FIG. 10, at a normalized frequency of 0.7 to 1.4, the pass amplitude difference between the pass amplitude from the first input terminal of the first transmission line to the output terminal of the unbalanced-side line and the pass amplitude from the second input terminal of the second transmission line to the output terminal of the unbalanced-side line in the first embodiment is improved by about 2.5 dB with respect to that in the comparative example.

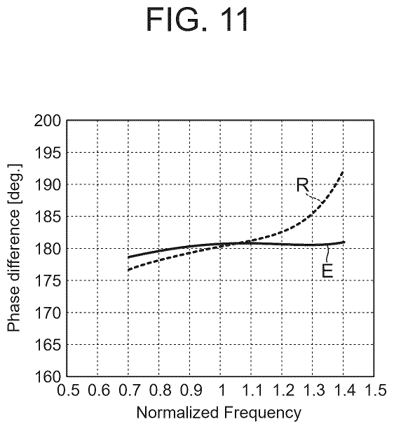

FIG. 11 is a diagram illustrating a pass phase difference between the first transmission line 2 and the second transmission line 3 with respect to the unbalanced-side line 4, which is one of the electromagnetic field analysis results of the balanced line-unbalanced line converter.

In FIG. 11, the horizontal axis represents the frequency normalized by the center frequency of a signal to be transmitted, the vertical axis represents the phase difference Phase difference [deg.], the solid line E represents the pass phase difference curve in the first embodiment, and the broken line R represents the pass phase difference curve in the comparative example.

As can be understood from FIG. 11, for the slope of the pass phase difference at a normalized frequency of 0.7 to 1.4, the first embodiment is smaller than the comparative example, and the pass phase difference of the first embodiment is about 180 degrees, which is ideal over a wide area.

As described above, since the balanced line-unbalanced line converter according to the first embodiment includes the first open stub 5 connected to the one end portion 31 of the second transmission line 3 and the second open stub 6 connected to the unbalanced-side line 4 and constituting the third coupled line C3 with the first open stub 5, the electrical characteristics of the balanced line-unbalanced line converter can be improved with a simple and compact configuration.

In addition, in the balanced line-unbalanced line converter according to the first embodiment, the pass phase difference between the first transmission line 2 and the second transmission line 3 caused by the parasitic inductance due to the connecting line portion 45 that is present in the unbalanced-side line 4 can be improved by the third coupled line C3.

In the balanced line-unbalanced line converter according to the first embodiment, since the first open stub 5 and the second open stub 6 are arranged inside the balanced-side line and the unbalanced-side line 4, even if the first open stub 5 and the second open stub 6 capable of improving the pass phase difference are provided, the size of the balanced line-unbalanced line converter is not affected, and the balanced line-unbalanced line converter can be downsized.

Note that, in a case where the balanced line-unbalanced line converter according to the first embodiment is used in an RFIC in order to enhance the function of the RFIC, the balanced line-unbalanced line converter according to the first embodiment may be formed using wiring layers on two different layers in an RFIC having a plurality of wiring layers.

In addition, the RFIC is configured to use a redistribution layer, which is a post-process technique of a semiconductor process, and the balanced line-unbalanced line converter according to the first embodiment may be formed by using wiring layers, that is, a wiring layer and a redistribution layer of the RFIC on two different layers.

Furthermore, in the case of an RFIC having a multilayer redistribution layer, the balanced line-unbalanced line converter according to the first embodiment may be formed using different layers in the redistribution layer in a state where various circuits formed in the RFIC and the redistribution layer are distinguished from each other.

### Second Embodiment

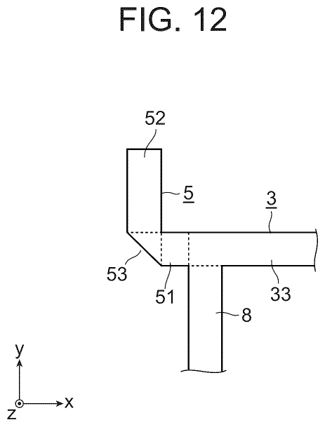

A balanced line-unbalanced line converter according to a second embodiment will be described with reference to FIG. 12.

In the balanced line-unbalanced line converter according to the first embodiment, the first open stub 5 includes the extending portion 51 that extends in the − direction of the X axis and the coupled portion 52 that extends from the extending portion 51 to be bent at a right angle in the + direction of the Y axis.

On the other hand, the balanced line-unbalanced line converter according to the second embodiment is different from the balanced line-unbalanced line converter according to the first embodiment in that a cutout 53 is provided on the outer side of the bent portion between the extending portion 51 and the coupled portion 52, and the other points are the same.

In FIG. 12, the same reference numerals as those in FIGS. 1 to 6 denote the same or corresponding parts.

Hereinafter, the first open stub 5, which is a difference from the balanced line-unbalanced line converter according to the first embodiment, will be mainly described, and description of other components will be omitted.

The first open stub 5 includes the extending portion 51 that extends inward, that is, in the − direction of the X axis from one end portion of the second transmission line 3 and the coupled portion 52 that extends from the extending portion 51 to be bent in the + direction of the Y axis and faces the second open stub 6.

The first open stub 5 has the cutout 53 on the outer side of the bent portion between the extending portion 51 and the coupled portion 52 in the extending portion 51.

The cutout 53 is a linearly cut cutout with an internal angle of 45 degrees from a contact point of the extending portion 51 and the coupled portion 52, which is located outside, toward the outer side of the extending portion 51.

The electrical characteristics can be adjusted by providing the cutout 53 on the outer side of the bent portion between the extending portion 51 and the coupled portion 52, that is, partially cutting the bent portion, in the state of excessive electrical capacitance due to the bent portions in the first transmission line 2 and the second transmission line 3 constituting the balanced-side line and the unbalanced-side line 4.

In particular, in the case of handling a high frequency, the state of excessive electrical capacitance that affects the high frequency can be adjusted by providing the cutout 53.

Note that the internal angle for the cutout 53 is not limited to 45 degrees, and the internal angle may be less than 90 degrees based on the capacitance.

A side end surface of the coupled portion 52 located on one end side of the first transmission line 2 is disposed on one end side of the first transmission line 2 with respect to the center line O-O illustrated in FIG. 3, similarly to the coupled portion 52 in the first embodiment.

The length of the first open stub 5, strictly the length of the coupled portion 52, is a length of a fraction of the wavelength at the center frequency of a signal to be transmitted, for example, a length of 1/30 wavelength to ¼ wavelength.

Note that the positional relationship between the first open stub 5 and the second open stub 6 may be shifted in the X-axis direction as described in the first embodiment, or may be configured in a manner the coupled portion of the first open stub 5 and the second open stub 6 overlap in the X-axis direction.

The balanced line-unbalanced line converter according to the second embodiment configured as described above also has effects similar to those of the balanced line-unbalanced line converter according to the first embodiment. In addition, by providing the cutout 53 in the first open stub 5, it is possible to easily adjust the state of excessive electrical capacitance due to the bent portions in the first transmission line 2 and the second transmission line 3 constituting the balanced-side line and the unbalanced-side line 4, and to adjust the electrical characteristics.

### Third Embodiment

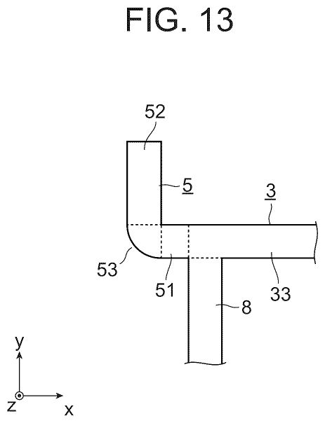

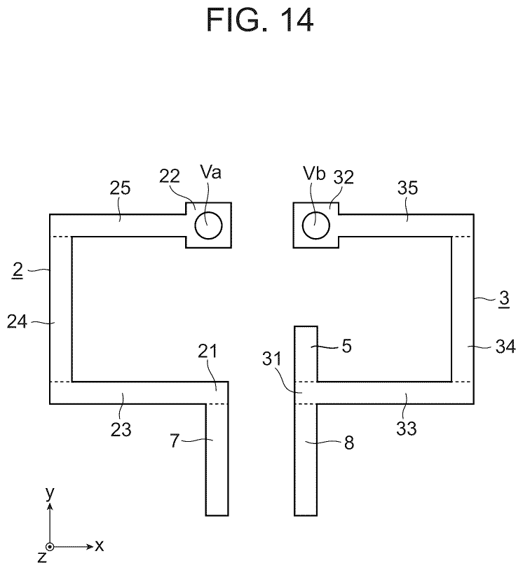

A balanced line-unbalanced line converter according to a third embodiment will be described with reference to FIG. 13.

In the balanced line-unbalanced line converter according to the first embodiment, the first open stub 5 includes the extending portion 51 that extends in the − direction of the X axis and the coupled portion 52 that extends from the extending portion 51 to be bent at a right angle in the + direction of the Y axis.

On the other hand, the balanced line-unbalanced line converter according to the third embodiment is different from the balanced line-unbalanced line converter according to the first embodiment in that an arc-shaped cutout 53 is provided on the outer side of the bent portion between the extending portion 51 and the coupled portion 52, and the other points are the same.

In FIG. 13, the same reference numerals as those in FIGS. 1 to 6 denote the same or corresponding parts.

Hereinafter, the first open stub 5, which is a difference from the balanced line-unbalanced line converter according to the first embodiment, will be mainly described, and description of other components will be omitted.

The first open stub 5 includes the extending portion 51 that extends inward, that is, in the − direction of the X axis from one end portion of the second transmission line 3 and the coupled portion 52 that extends from the extending portion 51 to be bent in the + direction of the Y axis and faces the second open stub 6.

The first open stub 5 has the arc-shaped cutout 53 on the outer side of the bent portion between the extending portion 51 and the coupled portion 52 in the extending portion 51.

The cutout 53 is a cutout cut out into a ¼ arc from a contact point of the extending portion 51 and the coupled portion 52, which is located outside, toward the outer side of the extending portion 51.

Since the first open stub 5 has the cutout 53, it is possible to easily adjust the state of excessive electrical capacitances due to the bent portions of the first transmission line 2 and the second transmission line 3 constituting the balanced-side line and the unbalanced-side line 4, and to adjust the electrical characteristics.

In addition, since the cutout 53 has an arc shape, a parasitic capacitance component that causes excessive capacitance can be further reduced.

Note that the cutout 53 is not limited to a ¼ arc, and only needs to have a shape in which a corner is rounded based on the adjustment amount of capacitance. A side end surface of the coupled portion 52 located on one end side of the first transmission line 2 is disposed on one end side of the first transmission line 2 with respect to the center line O-O illustrated in FIG. 3, similarly to the coupled portion 52 in the first embodiment.

The length of the first open stub 5, strictly the length of the coupled portion 52, is a length of a fraction of the wavelength at the center frequency of a signal to be transmitted, for example, a length of 1/30 wavelength to ¼ wavelength.

Note that the positional relationship between the first open stub 5 and the second open stub 6 may be shifted in the X-axis direction as described in the first embodiment, or may be configured in a manner that the coupled portion of the first open stub 5 and the second open stub 6 overlap in the X-axis direction.

The balanced line-unbalanced line converter according to the third embodiment configured as described above also has effects similar to those of the balanced line-unbalanced line converter according to the first embodiment. In addition, by providing the arc-shaped cutout 53 in the first open stub 5, it is possible to reduce and easily adjust the parasitic capacitance component that causes the state of excessive electrical capacitance due to the bent portions in the first transmission line 2 and the second transmission line 3 constituting the balanced-side line and the unbalanced-side line 4, and to adjust the electrical characteristics.

### Fourth Embodiment

A balanced line-unbalanced line converter according to a fourth embodiment will be described with reference to FIG. 14.

In the balanced line-unbalanced line converter according to the first embodiment, the first open stub 5 includes the extending portion 51 that extends in the − direction of the X axis and the coupled portion 52 that extends from the extending portion 51 to be bent at a right angle in the + direction of the Y axis.

On the other hand, the balanced line-unbalanced line converter according to the fourth embodiment is different from the balanced line-unbalanced line converter according to the first embodiment in that the first open stub 5 extends from the one end portion 31 of the second transmission line 3 to be bent at a right angle in the + direction of the Y axis and has a linear shape facing the second open stub 6, and the other points are the same.

In FIG. 14, the same reference numerals as those in FIGS. 1 to 6 denote the same or corresponding parts.

Hereinafter, the first open stub 5, which is a difference from the balanced line-unbalanced line converter according to the first embodiment, will be mainly described, and description of other components will be omitted.

The first open stub 5 extends inward from the first line portion 33, that is, is bent at a right angle in the + direction of the Y axis at the one end portion 31 of the second transmission line 3.

The first open stub 5 is continuous with the second signal line 8 along the Y axis.

The length of the first open stub 5 is a length of a fraction of the wavelength at the center frequency of a signal to be transmitted, for example, a length of 1/30 wavelength to ¼ wavelength.

The length of the first open stub 5 and the length of the second open stub 6 are substantially the same.

Note that the positional relationship between the first open stub 5 and the second open stub 6 may be shifted in the X-axis direction as described in the first embodiment, or may be configured in a manner that the first open stub 5 and the second open stub 6 overlap in the X-axis direction.

The balanced line-unbalanced line converter according to the fourth embodiment configured as described above also has effects similar to those of the balanced line-unbalanced line converter according to the first embodiment. In addition, the structure including the second transmission line 3, the second signal line 8, and the first open stub 5 can be simplified.

### Fifth Embodiment

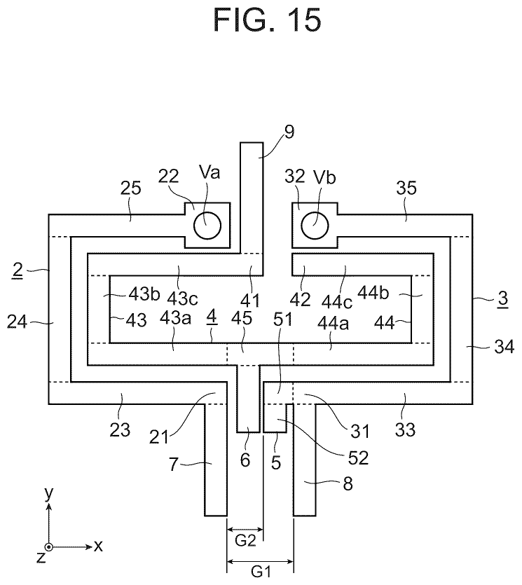

A balanced line-unbalanced line converter according to a fifth embodiment will be described with reference to FIG. 15.

In the balanced line-unbalanced line converter according to the first embodiment, the first transmission line 2 and the second transmission line 3 constituting the balanced-side line, the first open stub 5, the first signal line 7, and the second signal line 8 are formed in the first conductor layer 11 of the dielectric substrate 1, and the unbalanced-side line 4, the second open stub 6, and the third signal line 9 are formed in the second conductor layer 12 of the dielectric substrate 1.

That is, in the balanced line-unbalanced line converter according to the first embodiment, the first transmission line 2 and the second transmission line 3 constituting the balanced-side line and the unbalanced-side line 4 are broad-side coupled.

On the other hand, the balanced line-unbalanced line converter according to the fifth embodiment is different from the balanced line-unbalanced line converter according to the first embodiment in that the first transmission line 2 and the second transmission line 3 constituting the balanced-side line, the first open stub 5, the first signal line 7, the second signal line 8, the unbalanced-side line 4, the second open stub 6, and the third signal line 9 are formed in the same conductor layer of the dielectric substrate 1, and the other points are the same.

That is, in the balanced line-unbalanced line converter according to the fifth embodiment, the first transmission line 2 and the second transmission line 3 constituting the balanced-side line and the unbalanced-side line 4 are coplanarly coupled.

In this case, the distance between the first transmission line 2 and the second transmission line 3 constituting the balanced-side line, and the unbalanced-side line 4 is not increased, but is set to a distance at which the function and characteristics of the balanced line-unbalanced line converter can be obtained.

In FIG. 15, the same reference numerals as those in FIGS. 1 to 6 denote the same or corresponding parts.

Hereinafter, differences from the balanced line-unbalanced line converter according to the first embodiment will be mainly described.

The shapes of the first transmission line 2 and the first signal line 7 are similar to the shapes of the first transmission line 2 and the first signal line 7 in the first embodiment.

That is, it is configured as follows.

The one end portion 21 of the first transmission line 2 is connected to the first signal line 7, and the other end portion 22 of the first transmission line 2 is connected to the ground layer via the via Va.

The first transmission line 2 includes the first line portion 23 extending outward from the first signal line 7, the second line portion 24 extending from the first line portion 23 to be bent at a right angle, and the third line portion 25 extending from the second line portion 24 to be bent inward at a right angle.

The first signal line 7 is integrally formed by a conductor layer continuous with the first transmission line 2, and is bent at a right angle from the one end portion 21 of the first transmission line 2 to be linearly formed in the − direction of the Y axis. The shapes of the second transmission line 3 and the second signal line 8 are similar to the shapes of the second transmission line 3 and the second signal line 8 in the first embodiment.

That is, it is configured as follows.

The one end portion 31 of the second transmission line 3 is connected to the second signal line 8, and the other end portion 32 of the second transmission line 3 is connected to the ground layer via the via Vb.

An end surface of the one end portion 31 of the second transmission line 3 is disposed to face an end surface of the one end portion 21 of the first transmission line 2 with the gap G1 therebetween.

The first signal line 7 and the second signal line 8 are also arranged at the same interval as the gap G1.

The second transmission line 3 includes the first line portion 33 extending outward from the second signal line 8, the second line portion 34 extending from the first line portion 33 to be bent at a right angle, and the third line portion 35 extending from the second line portion 34 to be bent inward at a right angle.

The second signal line 8 is integrally formed by a conductor layer continuous with the second transmission line 3, and is bent at a right angle from the one end portion 31 of the second transmission line 3 to be linearly formed in the − direction of the Y axis.

The shape of the unbalanced-side line 4 is similar to the shape of the unbalanced-side line 4 in the first embodiment.

That is, it is configured as follows.

The unbalanced-side line 4 is formed in the same conductor layer as the first transmission line 2 and the second transmission line 3, and is disposed to face the first transmission line 2 and the second transmission line 3 in a region surrounded by the first transmission line 2 and the second transmission line 3.

The unbalanced-side line 4 includes the first transmission line portion 43 that constitutes the first coupled line C1 with the first transmission line 2, the second transmission line portion 44 that constitutes the second coupled line C2 with the second transmission line 3, and the connecting line portion 45 that is interposed between the first transmission line portion 43 and the second transmission line portion 44 to continuously form the first transmission line portion 43 and the second transmission line portion 44.

The one end portion 41 of the unbalanced-side line 4 is connected to the third signal line 9, and the other end portion 42 of the unbalanced-side line 4 is an open end.

An end surface of the one end portion 41 of the unbalanced-side line 4 is disposed to face an end surface of the other end portion 42 of the unbalanced-side line 4, and the unbalanced-side line 4 has a rectangular shape.

The one end portion 41 and the other end portion 42 of the unbalanced-side line 4 are arranged at positions facing the other end portion 22 of the first transmission line 2 and the other end portion 32 of the second transmission line 3, respectively.

One end portion of the first transmission line portion 43 of the unbalanced-side line 4 is the one end portion 41 of the unbalanced-side line 4, and the other end portion of the second transmission line portion 44 of the unbalanced-side line 4 is the other end portion 42 of the unbalanced-side line 4.

The third signal line 9 is formed linearly in the + direction of the Y axis, which is outward of the one end portion 41 of the unbalanced-side line 4, and extends outward from between the other end portion 22 of the first transmission line 2 and the other end portion 32 of the second transmission line 3.

The first transmission line portion 43 of the unbalanced-side line 4 includes the first line portion 43a, the second line portion 43b, and the third line portion 43c.

The first line portion 43a, the second line portion 43b, and the third line portion 43c in the first transmission line portion 43 are disposed to face the first line portion 23, the second line portion 24, and the third line portion 25 of the first transmission line 2, respectively.

The second transmission line portion 44 of the unbalanced-side line 4 includes the first line portion 44a, the second line portion 44b, and the third line portion 44c.

The first line portion 44a, the second line portion 44b, and the third line portion 44c in the second transmission line portion 44 are disposed to face the first line portion 33, the second line portion 34, and the third line portion 35 of the second transmission line 3, respectively.

The first open stub 5 is connected to one end portion of the second transmission line 3 constituting the balanced-side line.

The first open stub 5 is formed integrally with the second transmission line 3 at the end portion of the second transmission line 3 where the gap G1 between the first transmission line 2 and the second transmission line 3 is present.

The first open stub 5 extends outward, that is, in the − direction of the Y axis from one end portion of the second transmission line 3, and is interposed between the first signal line 7 and the second signal line 8.

The first open stub 5 includes the extending portion 51 that extends inward, that is, in the − direction of the X axis from one end portion of the second transmission line 3 and the coupled portion 52 that extends from the extending portion 51 to be bent at a right angle in the − direction of the Y axis and faces the second open stub 6.

The length of the first open stub 5, strictly the length of the coupled portion 52, is a length of a fraction of the wavelength at the center frequency of a signal to be transmitted, for example, a length of 1/30 wavelength to ¼ wavelength.

The second open stub 6 is connected to the unbalanced-side line 4.

The second open stub 6 constitutes the third coupled line C3 with the first open stub 5.

The second open stub 6 is connected to the connecting line portion 45 of the unbalanced-side line 4.

The second open stub 6 extends outward, that is, in the − direction of the Y axis from the connecting line portion 45 of the unbalanced-side line 4, faces the coupled portion 52 of the first open stub 5, and is interposed between the first signal line 7 and the second signal line 8.

The length of the second open stub 6, strictly the length of a portion disposed to face the coupled portion 52 of the first open stub 5, is a length of a fraction of the wavelength at the center frequency of a signal to be transmitted, for example, a length of 1/30 wavelength to ¼ wavelength.

The balanced line-unbalanced line converter according to the fifth embodiment configured as described above also has effects similar to those of the balanced line-unbalanced line converter according to the first embodiment.

Note that the balanced-side line and the unbalanced-side line 4 may be formed by strip lines, the balanced-side line and the unbalanced-side line 4 may be formed by microstrip lines, or one of the balanced-side line and the unbalanced-side line 4 may be formed by a strip line and the other may be formed by a microstrip line.

### Sixth Embodiment

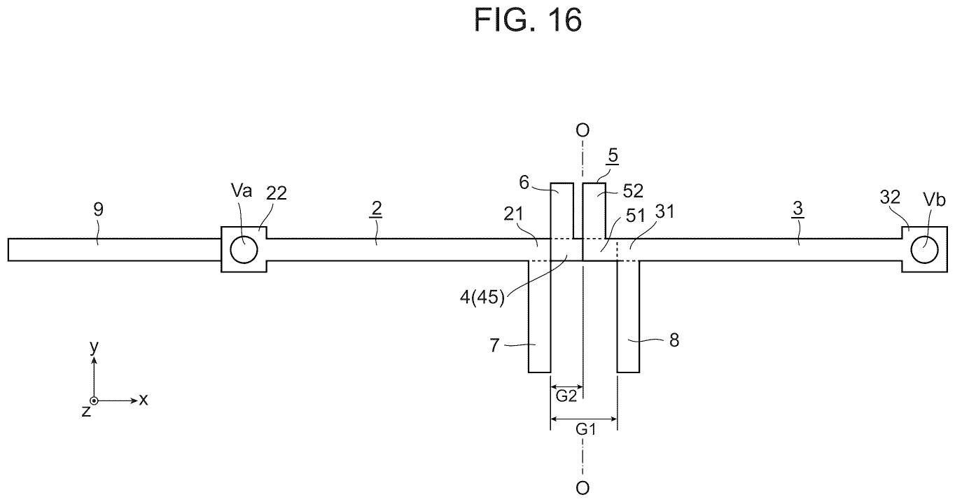

A balanced line-unbalanced line converter according to a sixth embodiment will be described with reference to FIGS. 16 to 18.

In the balanced line-unbalanced line converter according to the first embodiment, each of the first transmission line 2 and the second transmission line 3 is shaped to constitute three sides of a rectangle, the first transmission line 2 and the second transmission line 3 are arranged to face each other to constitute four sides of a rectangle, and the unbalanced-side line 4 is shaped to constitute four sides of a rectangle.

On the other hand, the balanced line-unbalanced line converter according to the sixth embodiment is different from the balanced line-unbalanced line converter according to the first embodiment in that the first transmission line 2 and the second transmission line 3 are formed in a straight line, and the unbalanced-side line 4 and the third signal line 9 are formed in a straight line, and the other points are the same.

In FIGS. 16 to 18, the same reference numerals as those in FIGS. 1 to 6 denote the same or corresponding parts.

Hereinafter, the first transmission line 2 and the second transmission line 3, the unbalanced-side line 4, and the third signal line 9, which are differences from the balanced line-unbalanced line converter according to the first embodiment, will be mainly described.

As illustrated in FIGS. 16 to 18, the balanced line-unbalanced line converter according to the sixth embodiment includes the multilayer dielectric substrate 1, the balanced-side line including the first transmission line 2 and the second transmission line 3, the unbalanced-side line 4, the first open stub 5, the second open stub 6, the first signal line 7, the second signal line 8, and the third signal line 9.

In the first transmission line 2 constituting the balanced-side line, one end portion 21 is a first signal terminal, and the other end portion 22 is short-circuited.

The first transmission line 2 is formed in the first conductor layer 11 of the dielectric substrate 1.

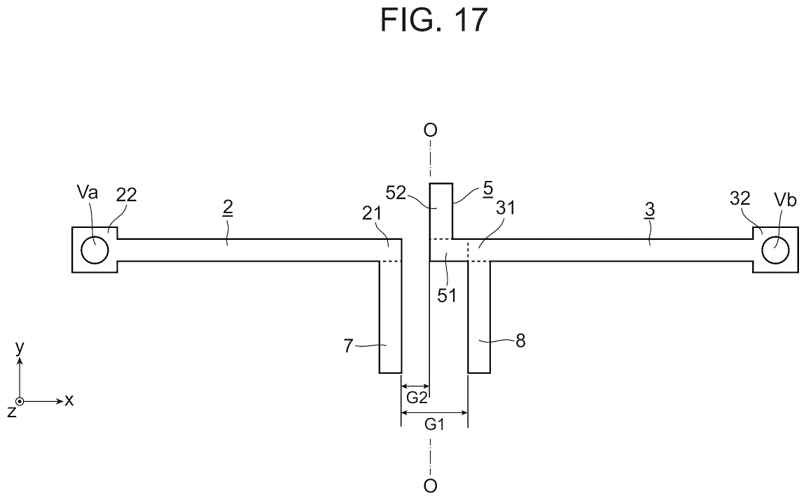

As illustrated in FIGS. 16 and 17, the first transmission line 2 is formed linearly in the − direction of the X axis, which is outward from the one end portion 21.

The one end portion 21 of the first transmission line 2 is connected to the first signal line 7 formed in the first conductor layer 11 of the dielectric substrate 1.

The first transmission line 2 and the first signal line 7 are integrally formed by a continuous conductor layer.

As illustrated in FIGS. 16 and 17, the first signal line 7 is bent at a right angle from the one end portion 21 of the first transmission line 2 to be formed linearly in the − direction of the Y axis.

The other end portion 22 of the first transmission line 2 is connected to the ground layer, in this example, the ground layer 14 on the back surface via the via Va.

The length of the first transmission line 2, that is, the length from the one end portion 21 to the other end portion 22 is a length of 90 degrees with respect to the center frequency of a signal to be transmitted.

In the second transmission line 3 constituting the balanced-side line, one end portion 31 is a second signal terminal, and the other end portion 32 is short-circuited.

The second transmission line 3 is formed in the first conductor layer 11 of the dielectric substrate 1.

As illustrated in FIGS. 16 and 17, the second transmission line 3 is formed linearly in the + direction of the X axis, which is outward from the one end portion 31.

An end surface of the one end portion 21 of the first transmission line 2 and an end surface of the one end portion 31 of the second transmission line 3 are arranged to face each other.

The end surface of the one end portion 21 of the first transmission line 2 and the end surface of the one end portion 31 of the second transmission line 3 are arranged with the gap G1 therebetween in order to obtain the impedance of the first transmission line 2 and the second transmission line 3.

The first transmission line 2 and the second transmission line 3 are arranged in a manner that the transmission directions of electromagnetic waves are opposite to each other.

The one end portion 31 of the second transmission line 3 is connected to the second signal line 8 formed in the first conductor layer 11 of the dielectric substrate 1.

The second transmission line 3 and the second signal line 8 are integrally formed by a continuous conductor layer.

As illustrated in FIGS. 16 and 17, the second signal line 8 is bent at a right angle from the one end portion 31 of the second transmission line 3 to be formed linearly in the − direction of the Y axis, and is disposed parallel with the first signal line 7.

The first signal line 7 and the second signal line 8 are also arranged at the same interval as the gap G1.

The other end portion 32 of the second transmission line 3 is connected to the ground layer, in this example, the ground layer 14 on the back surface via the via Vb.

The length of the second transmission line 3, that is, the length from the one end portion 31 to the other end portion 32 is a length of 90 degrees with respect to the center frequency of a signal to be transmitted.

In the unbalanced-side line 4, one end portion 41 is a third signal terminal, and the other end portion 42 is an open end.

The unbalanced-side line 4 includes the first transmission line portion 43 that constitutes the first coupled line C1 with the first transmission line 2, the second transmission line portion 44 that constitutes the second coupled line C2 with the second transmission line 3, and the connecting line portion 45 that connects the first transmission line portion 43 and the second transmission line portion 44.

The unbalanced-side line 4 is formed in the second conductor layer 12 of the dielectric substrate 1.

The first transmission line portion 43 of the unbalanced-side line 4 is disposed to face the first transmission line 2 in the Z-axis direction via an insulating layer. The second transmission line portion 44 of the unbalanced-side line 4 is disposed to face the second transmission line 3 in the Z-axis direction via an insulating layer.

The first transmission line portion 43 and the second transmission line portion 44 are continuously formed via the connecting line portion 45.

The one end portion 41 of the unbalanced-side line 4 is disposed at a position facing the other end portion 22 of the first transmission line 2 in the Z-axis direction via an insulating layer.

The other end portion 42 of the unbalanced-side line 4 is disposed at a position facing the other end portion 32 of the second transmission line 3 in the Z-axis direction via an insulating layer.

One end portion of the first transmission line portion 43 of the unbalanced-side line 4 is the one end portion 41 of the unbalanced-side line 4, and the other end portion of the second transmission line portion 44 of the unbalanced-side line 4 is the other end portion 42 of the unbalanced-side line 4.

An end surface of the one end portion 41 of the unbalanced-side line 4 is located on a plane formed in the Z-axis direction with an end surface of the other end portion 22 of the first transmission line 2.

An end surface of the other end portion 42 of the unbalanced-side line 4 is located on a plane formed in the Z-axis direction with an end surface of the other end portion 32 of the second transmission line 3.

The connecting line portion 45 of the unbalanced-side line 4 is disposed to face the gap G1 between the first transmission line 2 and the second transmission line 3 in the Z-axis direction via an insulating layer.

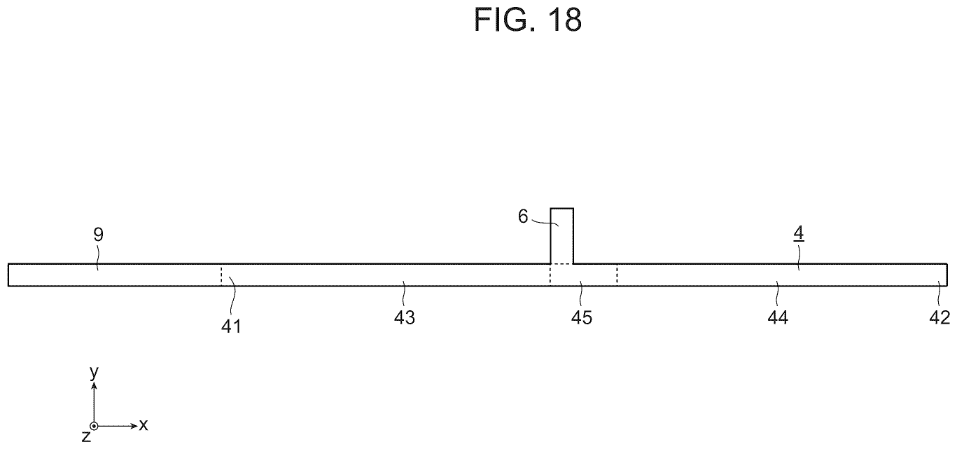

The first transmission line portion 43, the second transmission line portion 44, and the connecting line portion 45 in the unbalanced-side line 4 are integrally formed by a continuous conductor layer, and as illustrated in FIGS. 16 and 18, these portions are linearly formed parallel with the X axis from one end portion 41 to the other end portion 42.

The one end portion 41 of the unbalanced-side line 4 is connected to the third signal line 9 formed in the second conductor layer 12.

The unbalanced-side line 4 and the third signal line 9 are integrally formed by a continuous conductor layer.

As illustrated in FIGS. 16 and 18, the third signal line 9 is formed linearly in the − direction of the X axis from the one end portion 41 of the unbalanced-side line 4.

The length of the unbalanced-side line 4, that is, the length from the one end portion 41 to the other end portion 42 via the first transmission line portion 43, the second transmission line portion 44, and the connecting line portion 45 is a length of about 180 degrees with respect to the center frequency of a signal to be transmitted.

The first transmission line 2 and the second transmission line 3 constituting the balanced-side line, and the first signal line 7 and the second signal line 8 are formed as strip lines sandwiched between the ground layer 13 formed on the front surface of the dielectric substrate 1 and the ground layer 14 formed on the back surface.

The first transmission line portion 43, the second transmission line portion 44, and the connecting line portion 45 of the unbalanced-side line 4, and the third signal line are formed as strip lines sandwiched between the ground layer 13 and the ground layer 14.

Note that one of the balanced-side line and the unbalanced-side line 4 may be formed not by a strip line but by a microstrip line forming a line on the front surface or the back surface of the dielectric substrate 1.

As illustrated in FIG. 16, the first transmission line 2 constituting the balanced-side line and the first transmission line portion 43 of the unbalanced-side line 4, and the second transmission line 3 constituting the balanced-side line and the second transmission line portion 44 of the unbalanced-side line 4 completely overlap when viewed through the back surface of the dielectric substrate 1.

That is, the first transmission line 2, the second transmission line 3, and the unbalanced-side line 4 have the same width, and are linearly arranged along the X axis.

Since the first transmission line 2, the second transmission line 3, and the unbalanced-side line 4 are linear, the influence of discontinuity in propagation paths of a balanced signal and an unbalanced signal can be eliminated, and the parasitic inductance due to the connecting line portion 45 of the unbalanced-side line 4 can be apparently reduced more than in the case of the balanced line-unbalanced line converter according to the first embodiment, and the electrical characteristics are improved.

Note that, in order to adjust the coupling amount in the first coupled line C1 including the first transmission line 2 and the first transmission line portion 43 and the coupling amount in the second coupled line C2 including the second transmission line 3 and the second transmission line portion 44, the degree of overlap between the first transmission line 2 and the first transmission line portion 43 in the Y-axis direction and the degree of overlap between the second transmission line 3 and the second transmission line portion 44 in the Y-axis direction may be shifted.

In addition, the widths of the first transmission line 2, the second transmission line 3, and the unbalanced-side line 4 may be different depending on the characteristic impedance of each line.

The first open stub 5 is connected to the one end portion 31 of the second transmission line 3 constituting the balanced-side line.

The first open stub 5 is formed in the first conductor layer 11 of the dielectric substrate 1.

The first open stub 5 is formed integrally with the second transmission line 3 by the first conductor layer 11 at the end portion of the second transmission line 3 where the gap G1 between the first transmission line 2 and the second transmission line 3 is located.

The first open stub 5 extends from one end portion of the second transmission line 3 in the + direction of the Y axis, that is, to the opposite side to the second signal line 8.

As illustrated in FIGS. 16 and 17, the first open stub 5 includes the extending portion 51 that extends from the one end portion 31 of the second transmission line 3 in the − direction of the X axis and the coupled portion 52 that extends from the extending portion 51 to be bent at a right angle in the + direction of the Y axis and faces the second open stub 6.

A side end surface of the coupled portion 52 located on one end side of the first transmission line 2 is disposed on one end side of the first transmission line 2 with respect to the center line O-O illustrated in FIG. 16.

The length of the first open stub 5, strictly the length of the coupled portion 52, is a length of a fraction of the wavelength at the center frequency of a signal to be transmitted, for example, a length of 1/30 wavelength to ¼ wavelength.

For example, assuming that, in an RFIC, the balanced-side line including the first transmission line 2 and the second transmission line 3 and the unbalanced-side line 4 are respectively formed in the first conductor layer 11 and the second conductor layer 12 located in the inner layers of the multilayer dielectric substrate 1, and the thickness of the insulating layer between the first conductor layer 11 and the second conductor layer 12 is several microns, the length of the first open stub 5 is preferably about 1/20 wavelength.

The second open stub 6 is connected to the unbalanced-side line 4.

The second open stub 6 is formed in the second conductor layer 12 of the dielectric substrate 1.

The second open stub 6 constitutes the third coupled line C3 with the first open stub 5.

The second open stub 6 is connected to one end portion of the connecting line portion 45 of the unbalanced-side line 4.

The second open stub 6 extends from the connecting line portion 45 of the unbalanced-side line 4 in the + direction of the Y axis.

The second open stub 6 is disposed to face the first open stub 5 via the insulating layer, and is located on the first transmission line 2 side with respect to the first open stub 5 in the X-axis direction.

A side end surface of the second open stub 6 located on one end side of the second transmission line 3 is disposed on one end side of the first transmission line 2 with respect to the center line O-O illustrated in FIG. 16.

The second open stub 6 and the coupled portion 52 of the first open stub 5 are arranged as two straight lines parallel to the Y axis, and the second open stub 6 and the coupled portion 52 of the first open stub 5 constitute the third coupled line C3.

Since the parasitic inductance due to the connecting line portion 45 can be canceled by the capacitances of the first open stub 5 and the second open stub 6 constituting the third coupled line C3, it is possible to suppress deterioration in the electrical characteristics of the balanced line-unbalanced line converter caused by the parasitic inductance due to the connecting line portion 45, that is, deterioration of the pass phase difference between the first transmission line 2 and the second transmission line 3 in the balanced-side line, and to improve the pass phase difference.

In addition, since the extending portion 51 of the first open stub 5 acts to fill the gap G1 between the first transmission line 2 and the second transmission line 3, the pass phase difference between the first transmission line 2 and the second transmission line 3 can be further improved.

The length of the second open stub 6 is a length of a fraction of the wavelength at the center frequency of a signal to be transmitted, for example, a length of 1/30 wavelength to ¼ wavelength.

For example, assuming that, in the RFIC, the balanced-side line including the first transmission line 2 and the second transmission line 3 and the unbalanced-side line 4 are respectively formed in the first conductor layer 11 and the second conductor layer 12 located in the inner layers of the multilayer dielectric substrate 1, and the thickness of the insulating layer between the first conductor layer 11 and the second conductor layer 12 is several microns, the length of the second open stub 6 is preferably about 1/20 wavelength.

Note that the positional relationship between the first open stub 5 and the second open stub 6 only needs to obtain the set coupling amount in the third coupled line C3, and thus, as illustrated in FIG. 16, the positional relationship may be shifted in the X-axis direction, and the coupled portion 52 of the first open stub 5 and the second open stub 6 may overlap each other in the X-axis direction.

Next, an operation of the balanced line-unbalanced line converter according to the sixth embodiment will be described.

A balanced line-unbalanced line converter that converts a balanced signal into an unbalanced signal will be described.

The equivalent circuit diagram of the balanced line-unbalanced line converter according to the first embodiment is the same as the equivalent circuit diagram of the balanced line-unbalanced line converter according to the first embodiment illustrated in FIG. 7, and the operation is basically the same as the operation of the balanced line-unbalanced line converter according to the first embodiment.

As illustrated in FIG. 7, the third coupled line C3 including the first open stub 5 and the second open stub 6 is connected parallel with the connecting line portion 45.

Since the LC circuit including the inductance of the connecting line portion 45 and the capacitance of the third coupled line C3 performs impedance matching between the other end of the first transmission line portion 43 and one end of the second transmission line portion 44 in the unbalanced-side line 4, the pass phase difference between the first transmission line 2 and the second transmission line 3 with respect to the unbalanced-side line 4 is improved.

In addition, the gap G2 between the end surface of the extending portion 51 of the first open stub 5 and the end surface of the one end portion 21 of the first transmission line 2 is narrower than the gap G1 as illustrated in FIGS. 16 and 17, and thus the length of the connecting line portion 45 of the unbalanced-side line 4 can be substantially reduced. Therefore, the parasitic inductance due to the connecting line portion 45 can be reduced, and the deterioration in the electrical characteristics caused by the connecting line portion 45 can be reduced.

As a result, the pass phase difference between the first transmission line 2 and the second transmission line 3 can be improved.

As described above, since the balanced line-unbalanced line converter according to the sixth embodiment includes the first open stub 5 connected to the one end portion 31 of the second transmission line 3 and the second open stub connected to the unbalanced-side line 4 and constituting the third coupled line C3 with the first open stub 5, the pass phase difference between the first transmission line 2 and the second transmission line 3 caused by the parasitic inductance due to the connecting line portion 45 present in the unbalanced-side line 4 can be improved by the third coupled line C3, and the electrical characteristics of the balanced line-unbalanced line converter can be improved with a simple and compact configuration.

In addition, since the first transmission line 2, the second transmission line 3, and the unbalanced-side line 4 are linear in the balanced line-unbalanced line converter according to the sixth embodiment, the influence of discontinuity in propagation paths of a balanced signal and an unbalanced signal can be eliminated, and the electrical characteristics can be improved.

Note that, in a case where the balanced line-unbalanced line converter according to the sixth embodiment is used in an RFIC in order to enhance the function of the RFIC, the balanced line-unbalanced line converter according to the sixth embodiment may be formed using wiring layers on two different layers in an RFIC having a plurality of wiring layers.

In addition, the RFIC is configured to use a redistribution layer, which is a post-process technique of a semiconductor process, and the balanced line-unbalanced line converter according to the sixth embodiment may be formed by using wiring layers, that is, a wiring layer and a redistribution layer of the RFIC on two different layers.

Furthermore, in the case of an RFIC having a multilayer redistribution layer, the balanced line-unbalanced line converter according to the sixth embodiment may be formed using different layers in the redistribution layer in a state where various circuits formed in the RFIC and the redistribution layer are distinguished from each other.

Furthermore, the first open stub 5 may be shaped to have the cutout 53 on the outer side of the bent portion between the extending portion 51 and the coupled portion 52 as in the second embodiment, or may be shaped to have the arc-shaped cutout 53 on the outer side of the bent portion between the extending portion 51 and the coupled portion 52 as in the third embodiment.

Similarly to the idea described in the fourth embodiment, the first open stub 5 may have a linear shape that extends from the one end portion 31 of the second transmission line 3 to be bent at a right angle in the + direction of the Y axis and faces the second open stub 6.

That is, the first open stub 5 may extend from one end portion of the second transmission line 3 to be bent at a right angle in the + direction of the Y axis, that is, bent to the opposite side to the second signal line 8 and be continuous with the second signal line 8 along the Y axis.

The length of the first open stub 5 is equal to the length of the second open stub 6, and is a fraction of the wavelength at the center frequency of a signal to be transmitted, for example, a length of 1/30 wavelength to ¼ wavelength.

### Seventh Embodiment

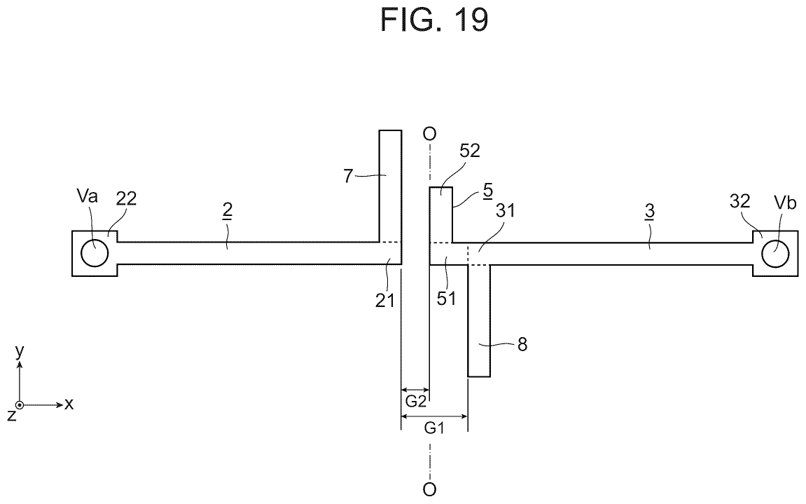

A balanced line-unbalanced line converter according to a seventh embodiment will be described with reference to FIG. 19.

In the balanced line-unbalanced line converter according to the sixth embodiment, the first signal line 7 and the second signal line 8 are respectively formed to extend from the one end portion 21 of the first transmission line 2 and the one end portion 31 of the second transmission line 3 in the − direction of the Y axis, which is the same direction.

On the other hand, the balanced line-unbalanced line converter according to the seventh embodiment is different from the balanced line-unbalanced line converter according to the sixth embodiment in that the first signal line 7 is formed to extend from the one end portion 21 of the first transmission line 2 in the + direction of the Y axis and the second signal line 8 is formed to extend from the one end portion 31 of the second transmission line 3 in the − direction of the Y axis, and the other points are the same.

In FIG. 19, the same reference numerals as those in FIGS. 16 to 18 denote the same or corresponding parts.

Hereinafter, the relationship between the first signal line 7 and the second signal line 8, which are differences from the balanced line-unbalanced line converter according to the sixth embodiment, the first transmission line 2, the second transmission line 3, and the first open stub 5 will be mainly described, and the description of other components will be omitted.

The first signal line 7 is integrally formed by a conductor layer continuous with the first transmission line 2, and is bent at a right angle from the one end portion 21 of the first transmission line 2 to be linearly formed in the + direction of the Y axis. The second signal line 8 is integrally formed by a conductor layer continuous with the second transmission line 3, and is bent at a right angle from the one end portion 31 of the second transmission line 3 to be linearly formed in the − direction of the Y axis.

The first signal line 7 and the second signal line 8 extend on opposite sides parallel to the Y axis with respect to a straight line along the X axis on which the first transmission line 2 and the second transmission line 3 are arranged.

The interval between the first transmission line 2 and the second transmission line 3, that is, the interval between the side surface of the first transmission line 2 and the side surface of the second transmission line 3 facing each other in the X-axis direction is the same as the gap G1 between the end surface of the one end portion 21 of the first transmission line 2 and the end surface of the one end portion 31 of the second transmission line 3.

The first open stub 5 includes the extending portion 51 that extends from the one end portion 31 of the second transmission line 3 in the − direction of the X axis and the coupled portion 52 that extends from the extending portion 51 to be bent at a right angle in the + direction of the Y axis and faces the second open stub 6.

The first signal line 7 and the coupled portion 52 of the first open stub 5 are arranged parallel at an interval.

The balanced line-unbalanced line converter according to the seventh embodiment configured as described above also has effects similar to those of the balanced line-unbalanced line converter according to the sixth embodiment.

Note that the first signal line 7 may be formed linearly in the − direction of the Y axis, and the second signal line 8 and the coupled portion 52 of the first open stub 5 may be formed linearly in the + direction of the Y axis.

Furthermore, the first open stub 5 may be shaped to have the cutout 53 on the outer side of the bent portion between the extending portion 51 and the coupled portion 52 as in the second embodiment, or may be shaped to have the arc-shaped cutout 53 on the outer side of the bent portion between the extending portion 51 and the coupled portion 52 as in the third embodiment.

Similarly to the idea described in the fourth embodiment, the first open stub 5 may have a linear shape that extends from the one end portion 31 of the second transmission line 3 to be bent at a right angle in the + direction of the Y axis and faces the second open stub 6.

### Eighth Embodiment

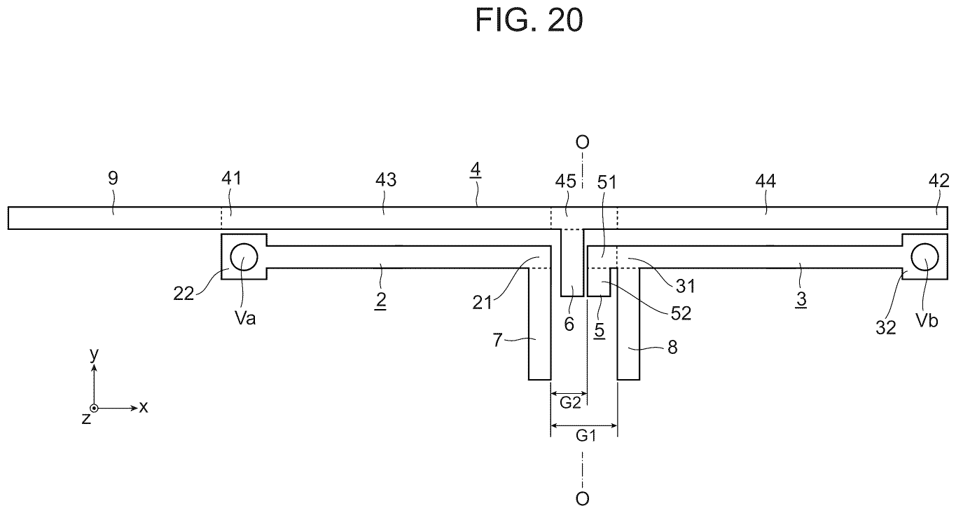

A balanced line-unbalanced line converter according to an eighth embodiment will be described with reference to FIG. 20.

In the balanced line-unbalanced line converter according to the sixth embodiment, the first transmission line 2 and the second transmission line 3 constituting the balanced-side line, the first open stub 5, the first signal line 7, and the second signal line 8 are formed in the first conductor layer 11 of the dielectric substrate 1, and the unbalanced-side line 4, the second open stub 6, and the third signal line 9 are formed in the second conductor layer 12 of the dielectric substrate 1.

That is, in the balanced line-unbalanced line converter according to the sixth embodiment, the first transmission line 2 and the second transmission line 3 constituting the balanced-side line and the unbalanced-side line 4 are broad-side coupled.

On the other hand, the balanced line-unbalanced line converter according to the eighth embodiment is different from the balanced line-unbalanced line converter according to the sixth embodiment in that the first transmission line 2 and the second transmission line 3 constituting the balanced-side line, the first open stub 5, the first signal line 7, and the second signal line 8, and the unbalanced-side line 4, the second open stub 6, and the third signal line 9 are formed in the same conductor layer of the dielectric substrate 1, and the other points are the same.

That is, in the balanced line-unbalanced line converter according to the eighth embodiment, the first transmission line 2 and the second transmission line 3 constituting the balanced-side line and the unbalanced-side line 4 are coplanarly coupled.

In this case, the distance between the first transmission line 2 and the second transmission line 3 constituting the balanced-side line, and the unbalanced-side line 4 is not increased, but is set to a distance at which the function and characteristics of the balanced line-unbalanced line converter can be obtained.

In FIG. 20, the same reference numerals as those in FIGS. 16 to 18 denote the same or corresponding parts.

Hereinafter, differences from the balanced line-unbalanced line converter according to the sixth embodiment will be mainly described.

The shapes of the first transmission line 2 and the first signal line 7 are similar to the shapes of the first transmission line 2 and the first signal line 7 in the sixth embodiment.

That is, it is configured as follows.

The one end portion 21 of the first transmission line 2 is connected to the first signal line 7, and the other end portion 22 of the first transmission line 2 is connected to the ground layer via the via Va.

The first transmission line 2 is formed linearly in the − direction of the X axis, which is outward from the one end portion 21.

The first signal line 7 is integrally formed by a conductor layer continuous with the first transmission line 2, and is bent at a right angle from the one end portion 21 of the first transmission line 2 to be linearly formed in the − direction of the Y axis.

The shapes of the second transmission line 3 and the second signal line 8 are similar to the shapes of the second transmission line 3 and the second signal line 8 in the sixth embodiment.

That is, it is configured as follows.

The one end portion 31 of the second transmission line 3 is connected to the second signal line 8, and the other end portion 32 of the second transmission line 3 is connected to the ground layer via the via Vb.

An end surface of the one end portion 31 of the second transmission line 3 is disposed to face an end surface of the one end portion 21 of the first transmission line 2 with the gap G1 therebetween.

The second transmission line 3 is formed linearly in the + direction of the X axis, which is outward from the one end portion 31.

The second signal line 8 is integrally formed by a conductor layer continuous with the second transmission line 3, and is bent at a right angle from the one end portion 31 of the second transmission line 3 to be linearly formed in the − direction of the Y axis.

The first signal line 7 and the second signal line 8 are also arranged at the same interval as the gap G1.

The shape of the unbalanced-side line 4 is similar to the shape of the unbalanced-side line 4 in the sixth embodiment.

That is, it is configured as follows.

The unbalanced-side line 4 is formed in the same conductor layer as the first transmission line 2 and the second transmission line 3.

The one end portion 41 of the unbalanced-side line 4 is connected to the third signal line 9, and the other end portion 42 of the unbalanced-side line 4 is an open end.

The unbalanced-side line 4 includes the first transmission line portion 43 that constitutes the first coupled line C1 with the first transmission line 2, the second transmission line portion 44 that constitutes the second coupled line C2 with the second transmission line 3, and the connecting line portion 45 that connects the first transmission line portion 43 and the second transmission line portion 44.

The unbalanced-side line 4 is linearly formed parallel with the X axis from the one end portion 41 to the other end portion 42, and the first transmission line portion 43, the second transmission line portion 44, and the connecting line portion 45 are formed in a straight line.

The first transmission line portion 43 is disposed to face the first transmission line 2 in the Y-axis direction, the second transmission line portion 44 is disposed to face the second transmission line 3 in the Y-axis direction, and the connecting line portion 45 is disposed to face the gap G1 between the first transmission line 2 and the second transmission line 3 in the Y-axis direction.

The third signal line 9 is integrally formed by a conductor layer continuous with the unbalanced-side line 4, and is formed linearly in the − direction of the X axis from the one end portion 41 of the unbalanced-side line 4.

The first open stub 5 includes the extending portion 51 that extends in the − direction of the X axis from one end portion of the second transmission line 3 and the coupled portion 52 that extends from the extending portion 51 to be bent at a right angle in the − direction of the Y axis and is interposed between the first signal line 7 and the second signal line 8.

The second open stub 6 extends from the connecting line portion 45 of the unbalanced-side line 4 in the − direction of the Y axis, faces the coupled portion 52 of the first open stub 5, and is interposed between the first signal line 7 and the second signal line 8.

The first open stub 5 and the second open stub 6 constitute the third coupled line C3.

The balanced line-unbalanced line converter according to the eighth embodiment configured as described above also has effects similar to those of the balanced line-unbalanced line converter according to the sixth embodiment.

Note that the balanced-side line and the unbalanced-side line 4 may be formed by strip lines, the balanced-side line and the unbalanced-side line 4 may be formed by microstrip lines, or one of the balanced-side line and the unbalanced-side line 4 may be formed by a strip line and the other may be formed by a microstrip line.

### Ninth Embodiment

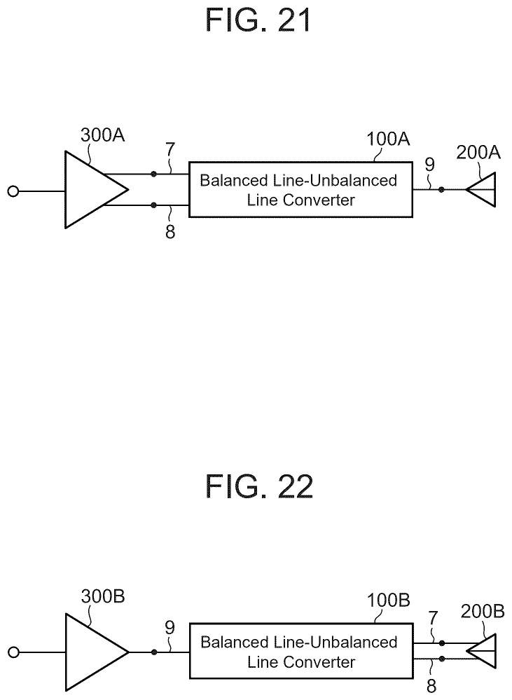

An antenna device according to a ninth embodiment will be described with reference to FIG. 21.

The antenna device according to the ninth embodiment includes an antenna element 200A, a signal source 300A, and a balanced line-unbalanced line converter 100A.

The balanced line-unbalanced line converter 100A is a balanced line-unbalanced line converter that converts a balanced signal, a so-called differential signal, into an unbalanced signal, a so-called single-phase signal, and is the balanced line-unbalanced line converter described in any of the first to eighth embodiments. Note that a transmitting antenna device will be described below.

A receiving antenna device is similar in configuration to the transmitting antenna device except for a component of an active circuit connected to an antenna element, that is, a reception circuit 300 that processes a signal obtained by the balanced line-unbalanced line converter 100 converting a reception signal based on radio waves received by the antenna element 200.

An unbalanced signal is input to the antenna element 200A, and the antenna element transmits radio waves based on the input unbalanced signal.

The antenna element 200A is a patch antenna or a slot antenna.

The antenna element 200A only needs to meet the design specification, and may be an antenna other than the patch antenna or the slot antenna.

The antenna element 200A is connected to the third signal line 9 functioning as an output signal line, and an unbalanced signal from the balanced line-unbalanced line converter 100A is input thereto.

The signal source 300A outputs a balanced signal for radio waves to be transmitted by the antenna element 200A.

The signal source 300A is an active circuit that refers to an active component such as an amplifier or a mixer.

Power for the radio waves to be transmitted from the antenna element 200A is supplied from an input line disposed at a preceding stage of the active circuit to the active circuit, and the input power is transmitted in the active circuit and output as a balanced signal.

The signal source 300A is connected to the first signal line 7 and the second signal line 8 functioning as input signal lines.

One balanced signal from the signal source 300A is input to the first transmission line 2 of the balanced line-unbalanced line converter 100A via the first signal line 7.

The other signal having a differential signal relationship with one balanced signal from the signal source 300A is input to the second transmission line 3 of the balanced line-unbalanced line converter 100A via the second signal line 8.

In the balanced line-unbalanced line converter 100A, one balanced signal input to the first transmission line 2 flows as an unbalanced signal to the first transmission line portion 43 by electromagnetic field coupling with the first transmission line portion 43 of the unbalanced-side line 4 constituting the first coupled line C1, and the other balanced signal input to the second transmission line 3 flows as an unbalanced signal to the second transmission line portion 44 by electromagnetic field coupling with the second transmission line portion 44 of the unbalanced-side line 4 constituting the second coupled line C2. The pass phase difference between the first transmission line 2 and the second transmission line 3 is improved by the third coupled line C3 constituted by the first open stub 5 and the second open stub 6 and the signal is output to the third signal line 9 as an unbalanced signal.

In the antenna device according to the ninth embodiment configured as described above, the balanced signal from the signal source 300A is output to the antenna element 200A as an unbalanced signal by the balanced line-unbalanced line converter 100A described in any one of the first to eighth embodiments, so that the size of the balanced line-unbalanced line converter 100A can be reduced to improve the electrical characteristics. Therefore, the antenna device can be downsized, and the electrical characteristics of the antenna device can be improved.

In the antenna device according to the ninth embodiment, the balanced line-unbalanced line converter 100A and the active circuit constituting the signal source 300A may be incorporated in the same multilayer dielectric substrate 1.

In addition, the balanced line-unbalanced line converter 100A may be formed in a multilayer dielectric layer (handled as a dielectric substrate in this example) provided on a printed circuit board, and the active circuit constituting the signal source 300A may be incorporated in an RFIC.

In this case, the dielectric layer in which the balanced line-unbalanced line converter 100A is formed and the RFIC having the active circuit incorporated therein may be electrically connected by wire bonding, and the RFIC may be flip-chip mounted on the printed circuit board using a conductive material such as a solder ball.

The antenna element 200A may also be mounted on an RFIC incorporated in the same multilayer dielectric substrate 1 as the balanced line-unbalanced line converter 100A and the active circuit constituting the signal source 300A to form an on-chip antenna.

Furthermore, the antenna element 200A may be formed on a printed circuit board in which the balanced line-unbalanced line converter 100A is formed in a dielectric layer.

### Tenth Embodiment

An antenna device according to a tenth embodiment will be described with reference to FIG. 22.

The antenna device according to the tenth embodiment includes an antenna element 200B, a signal source 300B, and a balanced line-unbalanced line converter 100B.

The balanced line-unbalanced line converter 100B is a balanced line-unbalanced line converter that converts an unbalanced signal, a so-called single-phase signal, into a balanced signal, a so-called differential signal, and is the balanced line-unbalanced line converter described in any of the first to eighth embodiments. Note that a transmitting antenna device will be described below.

A receiving antenna device is similar in configuration to the transmitting antenna device except for a component of an active circuit connected to an antenna element, that is, the reception circuit 300 that processes a signal obtained by the balanced line-unbalanced line converter 100 converting a reception signal based on radio waves received by the antenna element 200.

A balanced signal is input to the antenna element 200B, and the antenna element transmits radio waves based on the input balanced signal.

The antenna element 200B is any of a monopole antenna, a dipole antenna, and a Vivaldi antenna.

The antenna element 200B only needs to meet the design specification, and may be an antenna other than the monopole antenna, the dipole antenna, or the Vivaldi antenna.

The antenna element 200B is connected to the first signal line 7 and the second signal line 8 functioning as output signal lines, and a balanced signal from the balanced line-unbalanced line converter 100B is input thereto.

The signal source 300B outputs an unbalanced signal for radio waves to be transmitted by the antenna element 200B.

The signal source 300B is an active circuit that refers to an active component such as an amplifier or a mixer.

Power for the radio waves to be transmitted from the antenna element 200B is supplied from an input line disposed at the preceding stage of the active circuit to the active circuit, and the input power is transmitted in the active circuit and output as an unbalanced signal.

The signal source 300B is connected to the third signal line 9 functioning as an input signal line.

The unbalanced signal from the signal source 300B is input to the unbalanced-side line 4 of the balanced line-unbalanced line converter 100B via the third signal line 9.

In the balanced line-unbalanced line converter 100B, the unbalanced signal input to the unbalanced-side line 4 flows as one balanced signal to the first transmission line 2 by electromagnetic field coupling with the first transmission line 2 constituting the first coupled line C1 with the first transmission line portion 43, and flows as the other balanced signal to the second transmission line 3 by electromagnetic field coupling with the second transmission line 3 constituting the second coupled line C2 with the second transmission line portion 44. The pass phase difference between the first transmission line 2 and the second transmission line 3 is improved by the third coupled line C3 constituted by the first open stub 5 and the second open stub 6 and the signal is output to the first signal line 7 and the second signal line 8 as a balanced signal.

In the antenna device according to the tenth embodiment configured as described above, the unbalanced signal from the signal source 300B is output to the antenna element 200B as a balanced signal by the balanced line-unbalanced line converter 100B described in any one of the first to eighth embodiments, so that the size of the balanced line-unbalanced line converter 100B can be reduced to improve the electrical characteristics. Therefore, the antenna device can be downsized, and the electrical characteristics of the antenna device can be improved.

In the antenna device according to the tenth embodiment, the balanced line-unbalanced line converter 100B and the active circuit constituting the signal source 300B may be incorporated in the same multilayer dielectric substrate 1.

In addition, the balanced line-unbalanced line converter 100B may be formed in a multilayer dielectric layer provided on a printed circuit board, and the active circuit constituting the signal source 300B may be incorporated in an RFIC.

In this case, the dielectric layer in which the balanced line-unbalanced line converter 100B is formed and the RFIC having the active circuit incorporated therein may be electrically connected by wire bonding, and the RFIC may be flip-chip mounted on the printed circuit board using a conductive material such as a solder ball.

The antenna element 200B may also be mounted on an RFIC incorporated in the same multilayer dielectric substrate 1 as the balanced line-unbalanced line converter 100B and the active circuit constituting the signal source 300B to form an on-chip antenna.

Furthermore, the antenna element 200B may be formed on a printed circuit board in which the balanced line-unbalanced line converter 100B is formed in a dielectric layer.

### Eleventh Embodiment

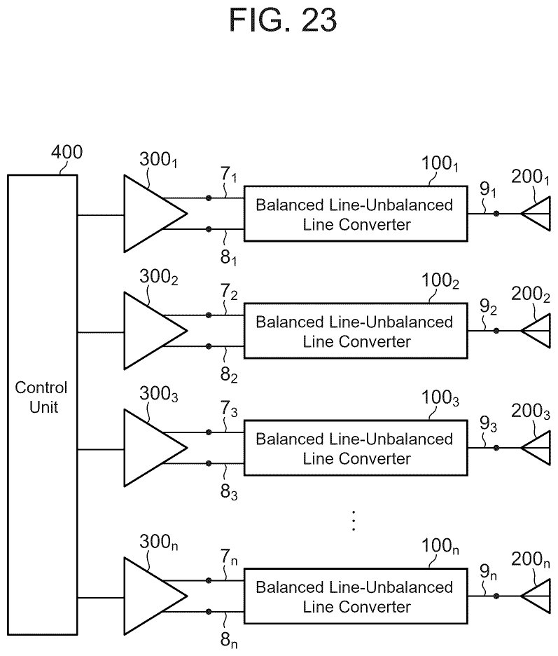

An antenna device according to an eleventh embodiment will be described with reference to FIG. 23.

The antenna device according to the eleventh embodiment is an array antenna device including a plurality of antenna elements 200₁ to 200ₙ.

That is, the antenna device according to the eleventh embodiment is an antenna device including n sets of antenna devices, each set including the antenna element 200A, the signal source 300A, and the balanced line-unbalanced line converter 100A described in the ninth embodiment. n is a natural number equal to or larger than 2, and plural.

Note that a transmitting antenna device will be described below.

A receiving antenna device is similar in configuration to the transmitting antenna device except for a component of an active circuit connected to an antenna element, that is, the reception circuit 300 that processes a signal obtained by the balanced line-unbalanced line converter 100 converting a reception signal based on radio waves received by the antenna element 200.

The antenna device according to the eleventh embodiment includes an antenna element crowd including a plurality of antenna elements 200₁ to 200ₙ, a signal source crowd including a plurality of signal sources 300₁ to 300ₙ, a converter crowd including a plurality of balanced line-unbalanced line converters 100₁ to 100ₙ, and a control unit 400.

Each of the balanced line-unbalanced line converter 100₁ to 100ₙ, each of the antenna elements 200₁ to 200ₙ, and each of the signal sources 300₁ to 300ₙ are provided to correspond to each other, which are respectively similar in configuration to the balanced line-unbalanced line converter 100A, the antenna element 200A, and the signal source 300A described in the ninth embodiment, and the balanced line-unbalanced line converter, the antenna element, and the signal source constitute one set.

That is, each of the balanced line-unbalanced line converters 100₁ to 100ₙ constituting the converter crowd is a balanced line-unbalanced line converter that converts a balanced signal, a so-called differential signal, into an unbalanced signal, a so-called single-phase signal, and is the balanced line-unbalanced line converter described in any of the first to eighth embodiments.

Each of the antenna elements 200₁ to 200ₙ constituting the antenna element crowd is connected to the corresponding one of the third signal lines 9₁ to 9ₙ functioning as output signal lines, and an unbalanced signal from the corresponding one of the balanced line-unbalanced line converters 100₁ to 100ₙ is input.

Each of the antenna elements 200₁ to 200ₙ transmits radio waves based on the unbalanced signal input from the corresponding one of the balanced line-unbalanced line converters 100₁ to 100ₙ.

Each of the antenna elements 200₁ to 200ₙ is similar to the antenna element 200A in the ninth embodiment.

Each of the signal sources 300₁ to 300ₙ constituting the signal source crowd corresponds to each of the antenna elements 200₁ to 200ₙ constituting the antenna element crowd.

Each of the signal sources 300₁ to 300ₙ outputs, as an output signal, a balanced signal for the radio waves to be transmitted by the corresponding one of the antenna elements 200₁ to 200ₙ.

Each of the signal sources 300₁ to 300ₙ is connected to the corresponding one of the first signal lines 7₁ to 7ₙ and the corresponding one of the second signal lines 8₁ to 8ₙ functioning as input signal lines.

One balanced signal from each of the signal sources 300₁ to 300ₙ is input to the first transmission line 2 of the corresponding one of the balanced line-unbalanced line converters 100₁ to 100ₙ via the corresponding one of the first signal lines 7₁ to 7ₙ.

The other balanced signal with a differential signal relationship with one balanced signal from each of the signal sources 300₁ to 300ₙ is input to the second transmission line 3 of the corresponding one of the balanced line-unbalanced line converters 100₁ to 100ₙ via the corresponding one of the second signal lines 8₁ to 8ₙ.

Each of the signal sources 300₁ to 300ₙ is similar to the signal source 300A in the ninth embodiment.

In each of the balanced line-unbalanced line converters 100₁ to 100ₙ, one balanced signal input to the first transmission line 2 flows as an unbalanced signal to the first transmission line portion 43 by electromagnetic field coupling with the first transmission line portion 43 of the unbalanced-side line 4 constituting the first coupled line C1, and the other balanced signal input to the second transmission line 3 flows as an unbalanced signal to the second transmission line portion 44 by electromagnetic field coupling with the second transmission line portion 44 of the unbalanced-side line 4 constituting the second coupled line C2. The pass phase difference between the first transmission line 2 and the second transmission line 3 is improved by the third coupled line C3 constituted by the first open stub 5 and the second open stub 6 and the signal is output to the third signal line 9 as an unbalanced signal.

The control unit 400 controls each of the signal sources 300₁ to 300ₙ constituting the signal source crowd, and controls the timing of supplying power to each of the signal sources 300₁ to 300ₙ and outputting a balanced signal for the input power.

Transmission of radio waves from each of the antenna elements 200₁ to 200ₙ constituting the antenna element crowd is controlled by control from the control unit 400, and the antenna device functions as an array antenna device.

The antenna device according to the eleventh embodiment configured as described above includes n sets each of which includes the antenna element, the signal source, and the balanced line-unbalanced line converter, and the balanced signal from each of the signal sources 300₁ to 300ₙ is output as the unbalanced signal to the corresponding one of the antenna elements 200₁ to 200ₙ by the corresponding one of the balanced line-unbalanced line converters 100₁ to ˜100ₙ described in any of the first to eighth embodiments. Therefore, it is possible to reduce the size of the converter crowd including the balanced line-unbalanced line converters 100₁ to 100ₙ and improve the electrical characteristics of each of the balanced line-unbalanced line converters 100₁ to 100ₙ, and it is possible to achieve downsizing of the array antenna device and then improve the electrical characteristics of the array antenna device.

In the antenna device according to the eleventh embodiment, the converter crowd and the active circuit constituting the signal source crowd may be incorporated in the same multilayer dielectric substrate 1.

In addition, the converter crowd may be formed in a multilayer dielectric layer provided on a printed circuit board, and the active circuit constituting the signal source crowd may be incorporated in an RFIC.

In this case, the dielectric layer in which the balanced line-unbalanced line converter 100A is formed and the RFIC having the active circuit incorporated therein may be electrically connected by wire bonding, and the RFIC may be flip-chip mounted on the printed circuit board using a conductive material such as a solder ball.

The antenna element crowd may also be mounted on an RFIC incorporated in the same multilayer dielectric substrate 1 as the converter crowd and the active circuit constituting the signal source crowd to form an on-chip array antenna.

Furthermore, the antenna element crowd may be formed on a printed circuit board in which the converter crowd is formed in a dielectric layer.

Note that the antenna device according to the eleventh embodiment is the antenna device including n sets of the antenna devices, each set including the antenna element 200A, the signal source 300A, and the balanced line-unbalanced line converter 100A described in the ninth embodiment, but as another antenna device, may be an antenna device that includes n sets of the antenna devices, each set including the antenna element 200B, the signal source 300B, and the balanced line-unbalanced line converter 100B described in the tenth embodiment and that is controlled by the control unit 400.

In this case, each of the balanced line-unbalanced line converters 100₁ to 100ₙ constituting the converter crowd is a balanced line-unbalanced line converter that converts an unbalanced signal, a so-called single-phase signal into a balanced signal, a so-called differential signal, and is the balanced line-unbalanced line converter described in any of the first to eighth embodiments.

Each of the antenna elements 200₁ to 200ₙ constituting the antenna element crowd transmits radio waves based on the balanced signal input from the corresponding one of the balanced line-unbalanced line converters 100₁ to 100ₙ, and is similar to the antenna element 300B in tenth embodiment.

Each of the signal sources 300₁ to 300ₙ constituting the signal source crowd outputs, as an output signal, an unbalanced signal for the radio waves to be transmitted by the corresponding one of the antenna elements 200₁ to 200ₙ to each of the balanced line-unbalanced line converters 100₁ to 100ₙ, and is similar to the signal source 200B in the tenth embodiment.

### Twelfth Embodiment

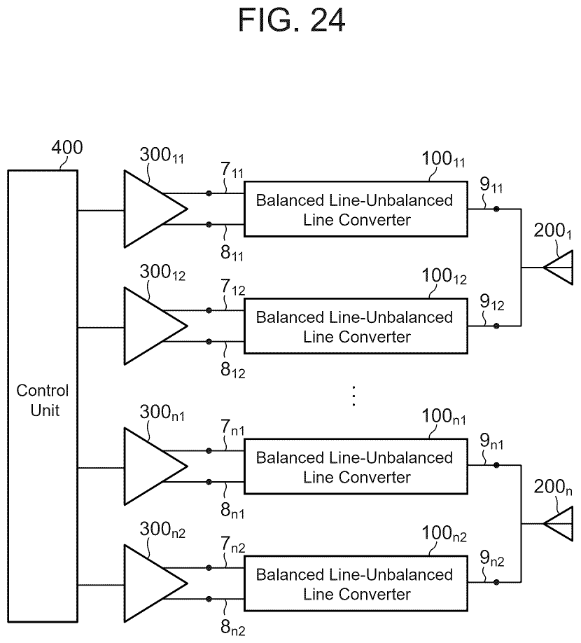

An antenna device according to a twelfth embodiment will be described with reference to FIG. 24.

The antenna device according to the twelfth embodiment is an array antenna device including a plurality of antenna elements 200₁ to 200ₙ.

The antenna device according to the eleventh embodiment is configured as one set in which the antenna elements 200₁ to 200ₙ respectively correspond to the balanced line-unbalanced line converters 100₁ to 100ₙ and the signal sources 300₁ to 300ₙ on a one-to-one basis.

On the other hand, the antenna device according to the twelfth embodiment is configured as one set in which the antenna elements 200₁ to 200ₙ individually correspond to the balanced line-unbalanced line converters 100₁₁ and 100₁₂ to 100ₙ₁ and 100ₙ₂ and the signal sources 300₁₁ and 300₁₂ to 300ₙ₁ and 300ₙ₂ at a ratio of 1:p (p is a natural number equal to or larger than 2, and plural).

In this example, a description will be given assuming that p=2.

Note that a transmitting antenna device will be described below.

A receiving antenna device is similar in configuration to the transmitting antenna device except for a component of an active circuit connected to an antenna element, that is, the reception circuit 300 that processes a signal obtained by the balanced line-unbalanced line converter 100 converting a reception signal based on radio waves received by the antenna element 200.

The antenna device according to the twelfth embodiment includes an antenna element crowd including the plurality of antenna elements 200₁ to 200ₙ, a signal source crowd including a plurality of signal source groups including the plurality of signal sources 300₁₁ and 300₁₂ to 300ₙ₁ and 300ₙ₂, a converter crowd including a plurality of converter groups including the plurality of balanced line-unbalanced line converters 100₁₁ and 100₁₂ to 100ₙ₁ and 100ₙ₂, the control unit 400, and a combining circuit crowd including a plurality of power combining circuits 500₁ to 500ₙ.

Each of the antenna elements 200₁ to 200ₙ corresponds to each of the signal source groups and each of the converter groups.

In this example, the individual converter groups include two balanced line-unbalanced line converters 100₁₁ and 100₁₂ to 100ₙ₁ and 100ₙ₂.

Each of the balanced line-unbalanced line converters 100₁₁ and 100₁₂ to 100ₙ₁ and 100ₙ₂ is a balanced line-unbalanced line converter that converts a balanced signal, a so-called differential signal, into an unbalanced signal, a so-called single-phase signal, and is the balanced line-unbalanced line converter described in any of the first to eighth embodiments.

Each of the plurality of power combining circuits 500₁ to 500ₙ constituting the combining circuit crowd corresponds to each of the plurality of antenna elements 200₁ to 200ₙ, and has a first input terminal, a second input terminal, and an output terminal.

Each of the power combining circuits 500₁ to 500ₙ combines the same unbalanced signals input to the first input terminal and the second input terminal and outputs the combined unbalanced signal from the output terminal as one unbalanced signal.

The first input terminal and the second input terminal of each of the power combining circuits 500₁ to 500ₙ are connected to the corresponding two of the third signal lines 9₁₁ and 9₁₂ to 9ₙ₁ and 9ₙ₂ that function as output signal lines from which unbalanced signals from the unbalanced-side lines 4 of the corresponding two of the balanced line-unbalanced line converters 100₁₁ and 100₁₂ to 100ₙ₁ and 100ₙ₂ in the corresponding one of the plurality of converter groups are output.

Each of the antenna elements 200₁ to 200ₙ constituting the antenna element crowd is connected to the output terminal of the corresponding one of the power combining circuits 500₁ to 500ₙ, and two unbalanced signals from two balanced line-unbalanced line converters 100₁₁ and 100₁₂ to 100ₙ₁ and 100ₙ₂ in the corresponding converter group are combined and input thereto.

Each of the antenna elements 200₁ to 200ₙ transmits radio waves based on an unbalanced signal obtained by combining two unbalanced signals.

The amount of power of each of the antenna elements 200₁ to 200ₙ is twice the amount of power of the unbalanced signal by each of the power combining circuit 500₁ to 500ₙ.

Each of the antenna elements 200₁ to 200ₙ is similar to the antenna element 200A in the ninth embodiment.

Each of the signal source groups constituting the signal source crowd corresponds to each of the antenna elements 200₁ to 200ₙ constituting the antenna element crowd.

In each of the signal source groups, two signal sources 300₁₁ and 300₁₂ to 300ₙ₁ and 300ₙ₂ are formed into one group in this example.

The two signal sources 300₁₁ and 300₁₂ to 300ₙ₁ and 300ₙ₂ constituting the signal source group output balanced signals for radio waves to be transmitted by the corresponding one of the antenna elements 200₁ to 200ₙ as output signals. Each of the two signal sources 300₁₁ and 300₁₂ to 300ₙ₁ and 300ₙ₂ constituting the signal source group is connected to two signal lines, that is, each of the first signal lines 7₁₁ and 7₁₂ to 7ₙ₁ and 7ₙ₂ and each of the second signal lines 8₁₁ and 8₁₂ to 8ₙ₁ and 8ₙ₂, these signal lines functioning as input signal lines corresponding to the individual signal source groups.

One balanced signal from each of the two signal sources 300₁₁ and 300₁₂ to 300ₙ₁ and 300ₙ₂ constituting each of the signal source groups is input to the first transmission line 2 of each of the balanced line-unbalanced line converters 100₁₁ and 100₁₂ to 100ₙ₁ and 100ₙ₂ in the converter group corresponding to the signal source group via each of the first signal lines 7₁₁ and 7₁₂ to 7ₙ₁ and 7ₙ₂ corresponding to each of the signal source groups.

The other balanced signal from each of the two signal sources 300₁₁ and 300₁₂ to 300ₙ₁ and 300ₙ₂ constituting each of the signal source groups is input to the second transmission line 3 of each of the balanced line-unbalanced line converters 100₁₁ and 100₁₂ to 100₁ and 100₁₂ in the converter group corresponding to the signal source group via each of the second signal lines 8₁₁ and 8₁₂ to 8ₙ₁ and 8ₙ₂ corresponding to each of the signal source groups.

Each of the signal sources 300₁₁ and 300₁₂ to 300ₙ₁ and 300ₙ₂ is similar to the signal source 300A in the ninth embodiment.

In each of the balanced line-unbalanced line converters 100₁₁ and 100₁₂ to 100ₙ₁ and 100ₙ₂, one balanced signal input to the first transmission line 2 flows as an unbalanced signal to the first transmission line portion 43 by electromagnetic field coupling with the first transmission line portion 43 of the unbalanced-side line 4 constituting the first coupled line C1, and the other balanced signal input to the second transmission line 3 flows as an unbalanced signal to the second transmission line portion 44 by electromagnetic field coupling with the second transmission line portion 44 of the unbalanced-side line 4 constituting the second coupled line C2. The pass phase difference between the first transmission line 2 and the second transmission line 3 is improved by the third coupled line C3 constituted by the first open stub 5 and the second open stub 6 and the signal is output to the third signal line 9 as an unbalanced signal.

The control unit 400 controls the individual signal sources 300₁₁ and 300₁₂ to 300ₙ₁ and 300ₙ₂ constituting the signal source crowd for each signal source group, and controls the timing of supplying power to each of the signal sources 300₁₁ and 300₁₂ to 300ₙ₁ and 300ₙ₂ and outputting a balanced signal for the input power.

Transmission of radio waves from each of the antenna elements 200₁ to 200ₙ constituting the antenna element crowd is controlled by control from the control unit 400, and the antenna device functions as an array antenna device.

The antenna device according to the twelfth embodiment configured as described above includes n sets each of which includes the antenna element, the signal source group including the plurality of signal sources, and the converter group including the plurality of balanced line-unbalanced line converters, and the balanced signal from each of the signal sources 300₁₁ and 300₁₂ to 300ₙ₁ and 300ₙ₂ controlled on a signal-source-group basis is output as the unbalanced signal to each of the antenna elements 200₁ to 200ₙ corresponding to the converter group by each of the balanced line-unbalanced line converters 100₁₁ and 100₁₂ to 100ₙ₁ and 100ₙ₂ described in any of the first to eighth embodiments in the converter group corresponding to the signal source group. Therefore, it is possible to reduce the size of the converter crowd including the balanced line-unbalanced line converters 100₁₁ and 100₁₂ to 100ₙ₁ and 100ₙ₂, improve the electrical characteristics of each of the balanced line-unbalanced line converters 100₁₁ and 100₁₂ to 100ₙ₁ and 100ₙ₂, and increase the amount of power to be supplied to each of the antenna elements 200₁ to 200ₙ. As a result, it is possible to achieve downsizing of the array antenna device, increase the power transmitted from each of the antenna elements 200₁ to 200ₙ, and then improve the electrical characteristics of the array antenna device.

In the antenna device according to the twelfth embodiment, the converter crowd, the active circuit constituting the signal source crowd, and the combining circuit crowd may be incorporated in the same multilayer dielectric substrate 1.

In addition, the converter crowd may be formed in a multilayer dielectric layer provided on a printed circuit board, the active circuit constituting the signal source crowd may be incorporated in an RFIC, and the combining circuit crowd may be formed on a printed circuit board.

In this case, the dielectric layer in which the converter crowd is formed and the RFIC having the active circuit incorporated therein may be electrically connected by wire bonding, and the RFIC may be flip-chip mounted on the printed circuit board using a conductive material such as a solder ball.

The antenna element crowd may also be mounted on an RFIC incorporated in the same multilayer dielectric substrate 1 as the converter crowd, the active circuit constituting the signal source crowd, and the combining circuit crowd to form an on-chip array antenna.

Furthermore, the antenna element crowd may be formed on a printed circuit board in which the converter crowd is formed in a dielectric layer.

Note that the antenna device according to the twelfth embodiment is the antenna device including n sets of the antenna devices each set including the antenna element 200A, the signal source group including the plurality of signal sources 300A, and the converter group including the plurality of balanced line-unbalanced line converters 100A described in the ninth embodiment, but as another antenna device, may be an antenna device that includes n sets of the antenna devices each set including the antenna element 200B, the signal source group including the plurality of signal sources 300B, and the converter group including the plurality of balanced line-unbalanced line converters 100B described in the tenth embodiment and that is controlled by the control unit 400.

In this case, each of the balanced line-unbalanced line converters 100₁₁ and 100₁₂ to 100ₙ₁ and 100ₙ₂ constituting the converter crowd is a balanced line-unbalanced line converter that converts an unbalanced signal, a so-called single-phase signal into a balanced signal, a so-called differential signal, and is the balanced line-unbalanced line converter described in any of the first to eighth embodiments.

Each of the antenna elements 200₁ to 200ₙ constituting the antenna element crowd transmits radio waves based on the balanced signal input from each of the balanced line-unbalanced line converters 100₁₁ and 100₁₂ to 100ₙ₁ and 100ₙ₂ constituting the corresponding converter group, and is similar to the antenna element 200B in tenth embodiment.

Each of the signal sources 300₁₁ and 300₁₂ to 300ₙ₁ and 300ₙ₂ constituting the signal source crowd outputs, as an output signal, an unbalanced signal for the radio waves to be transmitted by each of the antenna elements 200₁ to 200ₙ corresponding to the signal source group to each of the balanced line-unbalanced line converters 100₁₁ and 100₁₂ to 100₁ and 100ₙ₂ in the converter group corresponding to the signal source group, and the signal source is similar to the signal source 300B in the tenth embodiment.

### Thirteenth Embodiment

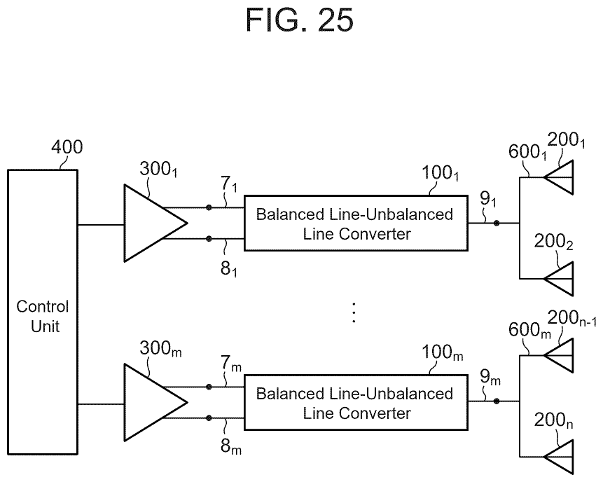

An antenna device according to a thirteenth embodiment will be described with reference to FIG. 25.

The antenna device according to the thirteenth embodiment is an array antenna device including a plurality of antenna elements 200₁ to 200ₙ.

The antenna device according to the eleventh embodiment is configured as one set in which the antenna elements 200₁ to 200ₙ respectively correspond to the balanced line-unbalanced line converters 100₁ to 100, and the signal sources 300₁ to 300ₙ on a one-to-one basis.

On the other hand, the antenna device according to the thirteenth embodiment is configured as one set in which the antenna elements 200₁ to 200ₙ individually correspond to the balanced line-unbalanced line converters 100₁ to 100ₘ and the signal sources 300₁ to 300ₘ at a ratio of 1:1/q.

Note that q is a natural number equal to or larger than 2, that is, plural, and m is n/q.

In this example, a description will be given assuming that q=2.

Note that a transmitting antenna device will be described below.

A receiving antenna device is similar in configuration to the transmitting antenna device except for a component of an active circuit connected to an antenna element, that is, the reception circuit 300 that processes a signal obtained by the balanced line-unbalanced line converter 100 converting a reception signal based on radio waves received by the antenna element 200.

The antenna device according to the thirteenth embodiment includes an antenna element crowd including a plurality of antenna element groups each of which includes the plurality of antenna elements 200₁ to 200ₙ, a signal source crowd including the plurality of signal sources 300₁ to 300ₘ corresponding to the plurality of antenna element groups, a converter crowd including the plurality of balanced line-unbalanced line converters 100₁ to 100ₘ corresponding to the plurality of antenna element groups, the control unit 400, and a dividing circuit crowd including a plurality of power dividing circuits 600₁ to 600ₘ.

Each of the plurality of antenna element groups, each of the plurality of signal sources 300₁ to 300ₘ, and each of the plurality of balanced line-unbalanced line converters 100₁ to 100ₘ correspond to each other.

The corresponding one of the plurality of antenna element groups, the corresponding one of the plurality of signal sources 300₁ to 300ₘ, and the corresponding one of the plurality of balanced line-unbalanced line converters 100₁ to 100ₘ constitute one sub-array.

In this example, a sub-array includes two antenna elements, one signal source, and one balanced line-unbalanced line converter, and an array antenna includes m sub-arrays.

Each of the balanced line-unbalanced line converters 100₁ to 100ₘ is a balanced line-unbalanced line converter that converts a balanced signal, a so-called differential signal, into an unbalanced signal, a so-called single-phase signal, and is the balanced line-unbalanced line converter described in any of the first to eighth embodiments.

Each of the plurality of power dividing circuits 600₁ to 600ₘ constituting the dividing circuit crowd corresponds to each of the plurality of antenna element groups, and has an input terminal, a first output terminal, and a second output terminal.

Each of the power dividing circuits 600₁ to 600ₘ divides an unbalanced signal input to the input terminal into two unbalanced signals, and outputs the same unbalanced signal to the first output terminal and the second output terminal. The input terminal of each of the power dividing circuits 600₁ to 600ₘ is connected to the corresponding one of the third signal lines 9₁ to 9ₘ functioning as output signal lines from which an unbalanced signal from the unbalanced-side line 4 of the corresponding one of the plurality of balanced line-unbalanced line converters 100₁ to 100ₘ is output.

Each of the antenna elements 200₁ to 200ₙ constituting the antenna element crowd is connected to the first output terminal or the second output terminal of each of the dividing circuits 600₁ to 600ₘ corresponding to each of the antenna element groups, and the unbalanced signal from each of the balanced line-unbalanced line converters 100₁ to 100ₘ corresponding to each of the antenna element groups is divided into two by the corresponding one of the dividing circuits 600₁ to 600ₘ and input.

Each of the antenna elements 200₁ to 200ₙ transmits radio waves based on the two unbalanced signals divided by each of the dividing circuits 600₁ to 600ₘ corresponding to each antenna element group.

Each of the antenna elements 200₁ to 200ₙ transmits radio waves based on the same unbalanced signal for each antenna element group, that is, for each sub-array.

In each of the antenna element groups, two antenna element 200₁ to 200ₙ are formed into one group in this example.

Each of the antenna elements 200₁ to 200ₙ is similar to the antenna element 200A in the ninth embodiment.

Each of the signal sources 300₁ to 300ₘ constituting the signal source crowd corresponds to each of the plurality of antenna element groups constituting the antenna element crowd.

Each of the signal sources 300₁ to 300ₘ is connected to two signal lines, that is, each of the first signal lines 7₁ to 7ₘ and each of the second signal lines 8₁ to 8ₘ, these signal lines functioning as corresponding input signal lines.

One balanced signal from each of the signal sources 300₁ to 300ₘ is input to the first transmission line 2 of the corresponding one of the balanced line-unbalanced line converters 100₁ to 100ₘ.

The other balanced signal from each of the signal sources 300₁ to 300ₘ is input to the second transmission line 3 of the corresponding one of the balanced line-unbalanced line converters 100₁ to 100ₘ.

Each of the signal sources 300₁ to 300ₘ is similar to the signal source 300A in the ninth embodiment.

In each of the balanced line-unbalanced line converters 100₁ to 100ₘ, one balanced signal input to the first transmission line 2 flows as an unbalanced signal to the first transmission line portion 43 by electromagnetic field coupling with the first transmission line portion 43 of the unbalanced-side line 4 constituting the first coupled line C1, and the other balanced signal input to the second transmission line 3 flows as an unbalanced signal to the second transmission line portion 44 by electromagnetic field coupling with the second transmission line portion 44 of the unbalanced-side line 4 constituting the second coupled line C2. The pass phase difference between the first transmission line 2 and the second transmission line 3 is improved by the third coupled line C3 constituted by the first open stub 5 and the second open stub 6 and the signal is output to the third signal line 9 as an unbalanced signal.

The control unit 400 controls each of the signal sources 300₁ to 300ₘ constituting the signal source crowd, and controls the timing of supplying power to each of the signal sources 300₁ to 300ₘ and outputting a balanced signal for the input power.

Transmission of radio waves from each of the antenna elements 200₁ to 200ₙ constituting the antenna element crowd is controlled for each antenna element group by control from the control unit 400, and the antenna device functions as an array antenna device acting as a sub-array for each antenna element group.

The antenna device according to the thirteenth embodiment configured as described above includes n sets each of which includes an antenna element group, the signal source, and the balanced line-unbalanced line converter, acts as a sub-array for each antenna element group, and the balanced signal from each of the signal sources 300₁ to 300ₘ is output as the unbalanced signal to the plurality of antenna elements 200₁ to 200ₙ for each corresponding antenna element group by the corresponding one of the balanced line-unbalanced line converters 100₁ to 100ₘ described in any of the first to eighth embodiments. Therefore, it is possible to reduce the size of the converter crowd including the balanced line-unbalanced line converters 100₁ to 100ₘ and improve the electrical characteristics of each of the balanced line-unbalanced line converters 100₁ to 100ₘ. As a result, it is possible to achieve downsizing of the array antenna device and then improve the electrical characteristics of the array antenna device.

In the antenna device according to the thirteenth embodiment, the converter crowd, the active circuit constituting the signal source crowd, and the dividing circuit crowd may be incorporated in the same multilayer dielectric substrate 1.

In addition, the converter crowd may be formed in a multilayer dielectric layer provided on a printed circuit board, the active circuit constituting the signal source crowd may be incorporated in an RFIC, and the dividing circuit crowd may be formed on the printed circuit board.

In this case, the dielectric layer in which the converter crowd is formed and the RFIC having the active circuit incorporated therein may be electrically connected by wire bonding, and the RFIC may be flip-chip mounted on the printed circuit board using a conductive material such as a solder ball.

The antenna element crowd may also be mounted on an RFIC incorporated in the same multilayer dielectric substrate 1 as the converter crowd, the active circuit constituting the signal source crowd, and the dividing circuit crowd to form an on-chip array antenna.

Furthermore, the antenna element crowd may be formed on a printed circuit board in which the converter crowd is formed in a dielectric layer.

Note that the antenna device according to the thirteenth embodiment is the antenna device including n sets of the antenna devices, each set including the plurality of antenna elements 200A constituting the antenna element group, the signal source 300A, and the balanced line-unbalanced line converter 100A described in the ninth embodiment, but as another antenna device, may be an antenna device that includes n sets of the antenna devices, each set including the antenna element 200B constituting the antenna element group, the signal source 300B, and the balanced line-unbalanced line converter 100B described in the tenth embodiment and that is controlled by the control unit 400.

In this case, each of the balanced line-unbalanced line converters 100₁ to 100ₘ constituting the converter crowd is a balanced line-unbalanced line converter that converts an unbalanced signal, a so-called single-phase signal into a balanced signal, a so-called differential signal, and is the balanced line-unbalanced line converter described in any of the first to eighth embodiments.

Each of the antenna elements 200₁ to 200ₙ constituting the antenna element crowd transmits radio waves based on the balanced signal input from each of the plurality of balanced line-unbalanced line converters 100₁ to 100ₘ corresponding to each antenna element group, and is similar to the antenna element 200B in tenth embodiment.

Each of the signal sources 300₁ to 300ₘ constituting the signal source crowd outputs, as an output signal, an unbalanced signal for the radio waves to be transmitted by the antenna elements 200₁ to 200ₙ for each corresponding antenna element group to each of the balanced line-unbalanced line converters 100₁ to 100ₘ respectively corresponding to the signal sources 300₁ to 300ₘ and is similar to the signal source 300B in the tenth embodiment.

Note that it is possible to freely combine the embodiments, modify any component of each embodiment, or omit any component of each embodiment.

### INDUSTRIAL APPLICABILITY

The balanced line-unbalanced line converter according to the present disclosure is suitable for a balanced line-unbalanced line converter that operates mainly at a high frequency such as in a sub-terahertz band or a terahertz band.

The balanced line-unbalanced line converter according to the present disclosure is suitable for a balanced line-unbalanced line converter used for communication and high-frequency devices such as radars.

### REFERENCE SIGNS LIST

100A, 100B, 100₁ to 100ₙ, 100₁₁, 100₁₂ to 100ₙ₁, 100ₙ₂: balanced line-unbalanced line converter, 1: dielectric substrate, 11: first conductor layer, 12: second conductor layer, 13, 14: ground layer, 2: first transmission line, 23: first line portion, 24: second line portion, 25: third line portion, 3: second transmission line, 33: first line portion, 34: second line portion, 35: third line portion, 4: unbalanced-side line, 43: first transmission line portion, 43a: first line portion, 43b: second line portion, 43c: third line portion, 44: second transmission line portion, 44a: first line portion, 44b: second line portion, 44c: third line portion, 45: connecting line portion, 5: first open stub, 51: extending portion, 52: coupled portion, 53: cutout, 6: second open stub, 7, 7₁ to 7ₙ, 7₁₁, 7₁₂ to 7ₙ₁, 7ₙ₂: first signal line, 8, 8₁ to 8ₙ, 8₁₁, 8₁₂ to 8ₙ₁, 8ₙ₂: second signal line, 9, 9₁ to 9ₙ, 9₁₁, 9₁₂ to 9ₙ₁ 9ₙ₂: third signal line, C1: first coupled line, C2: second coupled line, C3: third coupled line, 200A, 200B, 200₁ to 200ₙ: antenna element, 300A, 300B, 300₁ to 300ₙ, 300₁₁, 300₁₂ to 300ₙ₁, 300ₙ₂: active circuit, 400: control unit, 500₁ to 500ₙ: power combining circuit, 600₁ to 600ₘ: power dividing circuit.

1. A balanced line-unbalanced line converter comprising:
a balanced-side line including a first transmission line having a first end portion as a first signal terminal and a second end portion short-circuited, and a second transmission line having a first end portion as a second signal terminal and a second end portion short-circuited;
an unbalanced-side line including a first transmission line portion having a first end portion as a third signal terminal and a second end portion as an open end, the first transmission line portion to constitute a first coupled line with the first transmission line, and a second transmission line portion to constitute a second coupled line with the second transmission line;
a first open stub connected to the first end portion of the second transmission line; and
a second open stub connected to the unbalanced-side line, the second open stub to constitute a third coupled line with the first open stub.

2. The balanced line-unbalanced line converter according to claim 1, comprising
a multilayer dielectric substrate having a first conductor layer and a second conductor layer different from the first conductor layer, wherein
the balanced-side line and the first open stub are formed in the first conductor layer, and
the unbalanced-side line and the second open stub are formed in the second conductor layer.

3. The balanced line-unbalanced line converter according to claim 2, wherein
a first transmission line portion of the unbalanced-side line is disposed to face a first transmission line of the balanced-side line in an interlayer direction,
a second transmission line portion of the unbalanced-side line is disposed to face a second transmission line of the balanced-side line in the interlayer direction,
the unbalanced-side line includes a connecting line portion disposed to face a gap between the first transmission line and the second transmission line of the balanced-side line in the interlayer direction, and
the second open stub is connected to the connecting line portion of the unbalanced-side line.

4. The balanced line-unbalanced line converter according to claim 1, comprising
a multilayer dielectric substrate including a first conductor layer, a second conductor layer different from the first conductor layer, and a ground layer different from the first conductor layer and the second conductor layer, wherein
the first transmission line is formed in the first conductor layer, a first end portion of the first transmission line is connected to a first signal line formed in the first conductor layer, a second end portion of the first transmission line is connected to the ground layer, and the first transmission line includes a first line portion extending outward, a second line portion extending from the first line portion to be bent at a right angle, and a third line portion extending inward from the second line portion to be bent at a right angle,
the second transmission line is formed in the first conductor layer, a first end portion of the second transmission line is connected to a second signal line formed in the first conductor layer, a second end portion of the second transmission line is connected to the ground layer, an end surface of the first end portion of the second transmission line is disposed to face an end surface of the first end portion of the first transmission line with a gap between the end surfaces, and the second transmission line includes a first line portion extending outward, a second line portion extending from the first line portion to be bent at a right angle, and a third line portion extending from the second line portion to be bent at a right angle,
the unbalanced-side line is formed in the second conductor layer, a first end portion of the unbalanced-side line is connected to a third signal line formed in the second conductor layer, an end surface of the first end portion of the unbalanced-side line is disposed to face an end surface of a second end portion of the unbalanced-side line, the first end portion and the second end portion of the unbalanced-side line are arranged at positions facing the second end portion of the first transmission line and the second end portion of the second transmission line, a first end portion of a first transmission line portion of the unbalanced-side line is the first end portion of the unbalanced-side line, a second end portion of a second transmission line portion of the unbalanced-side line is the second end portion of the unbalanced-side line, the first transmission line portion and the second transmission line portion of the unbalanced-side line are continuously formed, the first transmission line portion of the unbalanced-side line includes a first line portion, a second line portion, and a third line portion arranged to face the first line portion, the second line portion, and the third line portion of the first transmission line, respectively, and the second transmission line portion of the unbalanced-side line includes a first line portion, a second line portion, and a third line portion arranged to face the first line portion, the second line portion, and the third line portion of the second transmission line, respectively,
the first open stub is formed in the first conductor layer and extends inward from the first end portion of the second transmission line, and
the second open stub is formed in the second conductor layer and extends inward from a connecting line portion of the unbalanced-side line disposed at a position facing the first end portion of the unbalanced-side line to face the first open stub.

5. The balanced line-unbalanced line converter according to claim 4, wherein the first open stub includes an extending portion extending inward from a first end portion of the second transmission line and a coupled portion extending from the extending portion to be bent inward and facing the second open stub.

6. The balanced line-unbalanced line converter according to claim 5, wherein the first open stub includes a cutout on an outer side of a bent portion between the extending portion and the coupled portion.

7. The balanced line-unbalanced line converter according to claim 5, wherein the first open stub includes an arc-shaped cutout on an outer side of a bent portion between the extending portion and the coupled portion.

8. The balanced line-unbalanced line converter according to claim 4, wherein the first open stub includes a coupled portion extending inward from a first end portion of the second transmission line and facing the second open stub.

9. The balanced line-unbalanced line converter according to claim 1, wherein a length of each of the first open stub and the second open stub is a length of 1/30 wavelength to ¼ wavelength of a wavelength at a center frequency of a signal to be transmitted.

10. The balanced line-unbalanced line converter according to claim 1, comprising
a multilayer dielectric substrate including a first conductor layer, a second conductor layer different from the first conductor layer, and a ground layer different from the first conductor layer and the second conductor layer, wherein
the first transmission line is formed linearly in the first conductor layer, and a first end portion of the first transmission line is connected to a first signal line formed in the first conductor layer, and a second end portion of the first transmission line is connected to the ground layer,
the second transmission line is formed in the first conductor layer, a first end portion of the second transmission line is connected to a second signal line formed in the first conductor layer, a second end portion of the second transmission line is connected to the ground layer, an end surface of the first end portion of the second transmission line is disposed to face an end surface of the first end portion of the first transmission line with a gap between the end surfaces, and the second transmission line and the first transmission line are arranged on a straight line,
the unbalanced-side line is formed linearly in the second conductor layer, a first end portion of the unbalanced-side line is connected to a third signal line formed in the second conductor layer, the first end portion and a second end portion of the unbalanced-side line are arranged at positions facing the second end portion of the first transmission line and the second end portion of the second transmission line, a first end portion of a first transmission line portion of the unbalanced-side line is the first end portion of the unbalanced-side line, a second end portion of a second transmission line portion of the unbalanced-side line is the second end portion of the unbalanced-side line, the first transmission line portion and the second transmission line portion of the unbalanced-side line are continuously formed, the first transmission line portion of the unbalanced-side line is disposed to face the first transmission line, and the second transmission line portion of the unbalanced-side line is disposed to face the second transmission line,
the first open stub is formed in the first conductor layer and extends from the first end portion of the second transmission line in a direction orthogonal to the second transmission line, and
the second open stub is formed in the second conductor layer and extends at a central portion of the unbalanced-side line in a direction orthogonal to the unbalanced-side line to face the first open stub.

11. The balanced line-unbalanced line converter according to claim 10, wherein the first open stub includes an extending portion extending from an end surface of a first end portion of the second transmission line to fill a gap between an end surface of a first end portion of the first transmission line and the end surface of the first end portion of the second transmission line, and a coupled portion extending from the extending portion to be bent at a right angle and facing the second open stub.

12. The balanced line-unbalanced line converter according to claim 11, wherein the first open stub includes a cutout on an outer side of a bent portion between the extending portion and the coupled portion.

13. The balanced line-unbalanced line converter according to claim 11, wherein the first open stub includes an arc-shaped cutout on an outer side of a bent portion between the extending portion and the coupled portion.

14. The balanced line-unbalanced line converter according to claim 10, wherein the first open stub includes a coupled portion extending from a first end portion of the second transmission line to be bent at a right angle and facing the second open stub.

15. The balanced line-unbalanced line converter according to claim 10, wherein a length of each of the first open stub and the second open stub is a length of 1/30 wavelength to ¼ wavelength of a wavelength at a center frequency of a signal to be transmitted.

16. The balanced line-unbalanced line converter according to claim 1, wherein the balanced-side line, the unbalanced-side line, the first open stub, and the second open stub are formed in a same conductor layer.

17. An antenna device comprising:
an antenna element to which an unbalanced signal is input, the antenna element to transmit a radio wave based on the unbalanced signal input;
a signal source to output a balanced signal for a radio wave to be transmitted by the antenna element; and
the balanced line-unbalanced line converter according to claim 1, to which a balanced signal from the signal source is input, the balanced line-unbalanced line converter to convert the balanced signal input into an unbalanced signal and output the unbalanced signal to the antenna element.

18. An antenna device comprising:
an antenna element to which an unbalanced signal is input, the antenna element to transmit a radio wave based on the unbalanced signal input;
a signal source to output a balanced signal for a radio wave to be transmitted by the antenna element; and
the balanced line-unbalanced line converter according to claim 9, to which a balanced signal from the signal source is input, the balanced line-unbalanced line converter to convert the balanced signal input into an unbalanced signal and output the unbalanced signal to the antenna element.

19. An antenna device comprising:
an antenna element to which an unbalanced signal is input, the antenna element to transmit a radio wave based on the unbalanced signal input;
a signal source to output a balanced signal for a radio wave to be transmitted by the antenna element; and
the balanced line-unbalanced line converter according to claim 15, to which a balanced signal from the signal source is input, the balanced line-unbalanced line converter to convert the balanced signal input into an unbalanced signal and output the unbalanced signal to the antenna element.

20. An antenna device comprising:
an antenna element to which a balanced signal is input, the antenna element to transmit a radio wave based on the balanced signal input;
a signal source to output an unbalanced signal for a radio wave to be transmitted by the antenna element; and
the balanced line-unbalanced line converter according to claim 1, to which an unbalanced signal from the signal source is input, the balanced line-unbalanced line converter to convert the unbalanced signal input into a balanced signal and output the balanced signal to the antenna element.

21. An antenna device comprising:
an antenna element to which a balanced signal is input, the antenna element to transmit a radio wave based on the balanced signal input;
a signal source to output an unbalanced signal for a radio wave to be transmitted by the antenna element; and
the balanced line-unbalanced line converter according to claim 9, to which an unbalanced signal from the signal source is input, the balanced line-unbalanced line converter to convert the unbalanced signal input into a balanced signal and output the balanced signal to the antenna element.

22. An antenna device comprising:
an antenna element to which a balanced signal is input, the antenna element to transmit a radio wave based on the balanced signal input;
a signal source to output an unbalanced signal for a radio wave to be transmitted by the antenna element; and
the balanced line-unbalanced line converter according to claim 15, to which an unbalanced signal from the signal source is input, the balanced line-unbalanced line converter to convert the unbalanced signal input into a balanced signal and output the balanced signal to the antenna element.

23. An antenna device comprising: an antenna element crowd including a plurality of antenna elements to each of which an unbalanced signal or a second balanced signal is input as an input signal, and each of which transmits a radio wave based on the input signal;
a signal source crowd including a plurality of signal sources each of which corresponds to each of the plurality of antenna elements of the antenna element crowd and outputs the unbalanced signal or a first balanced signal for a radio wave to be transmitted by a corresponding antenna element as an output signal; and
a converter crowd including a plurality of the balanced line-unbalanced line converters according to claim 1 each of which corresponds to each of the plurality of antenna elements of the antenna element crowd and each of the plurality of signal sources of the signal source crowd, to each of which an output signal from a corresponding signal source is input, and each of which converts the unbalanced signal or the first balanced signal input into the unbalanced signal or the second balanced signal and outputs the converted signal to the corresponding antenna element.

24. An antenna device comprising: an antenna element crowd including a plurality of antenna elements to each of which an unbalanced signal or a second balanced signal is input as an input signal, and each of which transmits a radio wave based on the input signal;
a signal source crowd including a plurality of signal sources each of which corresponds to each of the plurality of antenna elements of the antenna element crowd and outputs the unbalanced signal or a first balanced signal for a radio wave to be transmitted by a corresponding antenna element as an output signal; and
a converter crowd including a plurality of the balanced line-unbalanced line converters according to claim 9 each of which corresponds to each of the plurality of antenna elements of the antenna element crowd and each of the plurality of signal sources of the signal source crowd, to each of which an output signal from a corresponding signal source is input, and each of which converts the unbalanced signal or the first balanced signal input into the unbalanced signal or the second balanced signal and outputs the converted signal to the corresponding antenna element.

25. An antenna device comprising: an antenna element crowd including a plurality of antenna elements to each of which an unbalanced signal or a second balanced signal is input as an input signal, and each of which transmits a radio wave based on the input signal;
a signal source crowd including a plurality of signal sources each of which corresponds to each of the plurality of antenna elements of the antenna element crowd and outputs the unbalanced signal or a first balanced signal for a radio wave to be transmitted by a corresponding antenna element as an output signal; and
a converter crowd including a plurality of the balanced line-unbalanced line converters according to claim 15 each of which corresponds to each of the plurality of antenna elements of the antenna element crowd and each of the plurality of signal sources of the signal source crowd, to each of which an output signal from a corresponding signal source is input, and each of which converts the unbalanced signal or the first balanced signal input into the unbalanced signal or the second balanced signal and outputs the converted signal to the corresponding antenna element.

26. An antenna device comprising:
an antenna element crowd including a plurality of antenna elements to each of which an unbalanced signal or a second balanced signal is input as an input signal, and each of which transmits a radio wave based on the input signal;
a signal source crowd including a plurality of signal source groups including a plurality of signal sources, each of the signal source groups corresponding to each of the plurality of antenna elements of the antenna element crowd, and each of the signal sources outputting the unbalanced signal or a first balanced signal for a radio wave to be transmitted by a corresponding antenna element as an output signal; and
a converter crowd including a plurality of converter groups including a plurality of the balanced line-unbalanced line converters according to claim 1, each of the converter groups corresponding to each of the plurality of antenna elements of the antenna element crowd and each of the plurality of signal source groups of the signal source crowd, output signals from a plurality of signal sources of a corresponding signal source group being input to each of the converter groups, and each of the balanced line-unbalanced line converters converting the unbalanced signal or the first balanced signal input into the unbalanced signal or the second balanced signal and outputting the converted signal to the corresponding antenna element via a corresponding power combining circuit.

27. An antenna device comprising:
an antenna element crowd including a plurality of antenna elements to each of which an unbalanced signal or a second balanced signal is input as an input signal, and each of which transmits a radio wave based on the input signal;
a signal source crowd including a plurality of signal source groups including a plurality of signal sources, each of the signal source groups corresponding to each of the plurality of antenna elements of the antenna element crowd, and each of the signal sources outputting the unbalanced signal or a first balanced signal for a radio wave to be transmitted by a corresponding antenna element as an output signal; and
a converter crowd including a plurality of converter groups including a plurality of the balanced line-unbalanced line converters according to claim 9, each of the converter groups corresponding to each of the plurality of antenna elements of the antenna element crowd and each of the plurality of signal source groups of the signal source crowd, output signals from a plurality of signal sources of a corresponding signal source group being input to each of the converter groups, and each of the balanced line-unbalanced line converters converting the unbalanced signal or the first balanced signal input into the unbalanced signal or the second balanced signal and outputting the converted signal to the corresponding antenna element via a corresponding power combining circuit.

28. An antenna device comprising:
an antenna element crowd including a plurality of antenna elements to each of which an unbalanced signal or a second balanced signal is input as an input signal, and each of which transmits a radio wave based on the input signal;
a signal source crowd including a plurality of signal source groups including a plurality of signal sources, each of the signal source groups corresponding to each of the plurality of antenna elements of the antenna element crowd, and each of the signal sources outputting the unbalanced signal or a first balanced signal for a radio wave to be transmitted by a corresponding antenna element as an output signal; and
a converter crowd including a plurality of converter groups including a plurality of the balanced line-unbalanced line converters according to claim 15, each of the converter groups corresponding to each of the plurality of antenna elements of the antenna element crowd and each of the plurality of signal source groups of the signal source crowd, output signals from a plurality of signal sources of a corresponding signal source group being input to each of the converter groups, and each of the balanced line-unbalanced line converters converting the unbalanced signal or the first balanced signal input into the unbalanced signal or the second balanced signal and outputting the converted signal to the corresponding antenna element via a corresponding power combining circuit.

29. An antenna device comprising:
an antenna element crowd including a plurality of antenna element groups including a plurality of antenna elements to each of which an unbalanced signal or a second balanced signal is input as an input signal, and each of which transmits a radio wave based on the input signal;
a signal source crowd including a plurality of signal sources each of which corresponds to each of the plurality of antenna element groups of the antenna element crowd, and outputs the unbalanced signal or a first balanced signal for a radio wave to be transmitted by a plurality of antenna elements of a corresponding antenna element group as an output signal; and
a converter crowd including a plurality of the balanced line-unbalanced line converters according to claim 1, each of which corresponds to each of the plurality of antenna element groups of the antenna element crowd and each of the plurality of signal sources of the signal source crowd, to each of which an output signal from a corresponding signal source is input, and each of which converts the unbalanced signal or the first balanced signal input into the unbalanced signal or the second balanced signal and outputs the converted signal to the plurality of antenna elements of the corresponding antenna element group via a corresponding power dividing circuit.

30. An antenna device comprising:
an antenna element crowd including a plurality of antenna element groups including a plurality of antenna elements to each of which an unbalanced signal or a second balanced signal is input as an input signal, and each of which transmits a radio wave based on the input signal;
a signal source crowd including a plurality of signal sources each of which corresponds to each of the plurality of antenna element groups of the antenna element crowd, and outputs the unbalanced signal or a first balanced signal for a radio wave to be transmitted by a plurality of antenna elements of a corresponding antenna element group as an output signal; and
a converter crowd including a plurality of the balanced line-unbalanced line converters according to claim 9, each of which corresponds to each of the plurality of antenna element groups of the antenna element crowd and each of the plurality of signal sources of the signal source crowd, to each of which an output signal from a corresponding signal source is input, and each of which converts the unbalanced signal or the first balanced signal input into the unbalanced signal or the second balanced signal and outputs the converted signal to the plurality of antenna elements of the corresponding antenna element group via a corresponding power dividing circuit.

31. An antenna device comprising:
an antenna element crowd including a plurality of antenna element groups including a plurality of antenna elements to each of which an unbalanced signal or a second balanced signal is input as an input signal, and each of which transmits a radio wave based on the input signal;
a signal source crowd including a plurality of signal sources each of which corresponds to each of the plurality of antenna element groups of the antenna element crowd, and outputs the unbalanced signal or a first balanced signal for a radio wave to be transmitted by a plurality of antenna elements of a corresponding antenna element group as an output signal; and
a converter crowd including a plurality of the balanced line-unbalanced line converters according to claim 15, each of which corresponds to each of the plurality of antenna element groups of the antenna element crowd and each of the plurality of signal sources of the signal source crowd, to each of which an output signal from a corresponding signal source is input, and each of which converts the unbalanced signal or the first balanced signal input into the unbalanced signal or the second balanced signal and outputs the converted signal to the plurality of antenna elements of the corresponding antenna element group via a corresponding power dividing circuit.
